(19) United States
(12) Patent Application Publication
(10) Pub. No.: US 2020/0301311 A1
(43) Pub. Date: Sep. 24, 2020

(54) IMAGE FORMING APPARATUS AND PROCESS CARTRIDGE HAVING ELECTROSTATIC IMAGE DEVELOPING TONER WITH SPECIFIED VISCOSITY

(71) Applicant: FUJI XEROX CO., LTD., Tokyo (JP)

(72) Inventors: Takafumi Koide, Kanagawa (JP); Yusuke Fukuda, Kanagawa (JP); Katsuyuki Kitajima, Kanagawa (JP); Yasuhisa Morooka, Kanagawa (JP)

(73) Assignee: FUJI XEROX CO., LTD., Tokyo (JP)

(21) Appl. No.: 16/545,593

(22) Filed: Aug. 20, 2019

(30) Foreign Application Priority Data
Mar. 19, 2019 (JP) 2019-050903

(51) Int. Cl. G03G 15/08; G03G 9/087; G03G 9/09; G03G 21/18

(52) U.S. Cl. CPC G03G 15/0812; G03G 21/18; G03G 9/092; G03G 9/08711

(57) ABSTRACT

An image forming apparatus includes an image carrier; a charging unit that charges a surface of the image carrier; an electrostatic image forming unit that forms an electrostatic image on the charged surface of the image carrier; a developing unit that includes a container and a supply member and develops the electrostatic image formed on the surface of the image carrier to form a toner image, the container containing an electrostatic image developer that contains an electrostatic image developing toner and a carrier, the supply member having in a circumferential surface thereof plural grooves extending in a direction intersecting a direction of rotation of the supply member, the electrostatic image being developed with the electrostatic image developer; a transfer unit that transfers the toner image formed on the surface of the image carrier to a recording medium; and a fixing unit that fixes the toner image transferred to the recording medium. The electrostatic image developing toner satisfies the following inequalities: (ln η(T1)−ln η(T2))/(T1−T2)≤−0.14, (ln η(T2)−ln η(T3))/(T2−T3)≥−0.15, and (ln η(T1)−ln η(T2))/(T1−T2)<(ln η(T2)−ln η(T3))/(T2−T3), wherein η(T1) represents a viscosity of the electrostatic image developing toner at 60° C., η(T2) represents a viscosity of the electrostatic image developing toner at 90° C., and η(T3) represents a viscosity of the electrostatic image developing toner at 130° C.

### CROSS-REFERENCE TO RELATED APPLICATIONS

This application is based on and claims priority under 35 USC 119 from Japanese Patent Application No. 2019-050903 filed Mar. 19, 2019.

### BACKGROUND

### (i) Technical Field

The present disclosure relates to an image forming apparatus and a process cartridge.

### (ii) Related Art

Techniques such as electrophotography for visualization of image information via electrostatic images are currently used in various fields.

In the related art, electrophotography typically involves visualizing image information through a plurality of steps including forming an electrostatic image on a photoreceptor or an electrostatic recording medium using various techniques, developing the electrostatic latent image (toner image) by attaching electroscopic particles, which are called toner, to the electrostatic latent image, transferring the developed image onto a surface of a recording medium, and fixing the image by, for example, heating.

Japanese Laid Opened Patent Application Publication No. 2005-24611 discloses a developing device including a developer carrier that carries and transports a developer. The developer carried by the developer carrier is transported to a development area where an image carrier and the developer carrier face each other with a gap G therebetween, and an electrostatic latent image formed on the image carrier is developed by the developer to form a toner image. The developer carrier has in its surface a plurality of grooves extending in the longitudinal direction, and the product of an average depth H of the grooves and the gap G is 0.05 mm² or more and 0.1 mm² or less.

Japanese Laid Opened Patent Application Publication No. 11-194542 discloses an electrophotographic toner containing a binder resin and a coloring agent. The minimum tan δ of the binder resin is located between the glass transition temperature (Tg) of the resin and the temperature at which the loss modulus (G″) of the resin reaches 1×10⁴ Pa. The minimum tan δ is less than 1.2. The storage modulus (G′) at the temperature corresponding to the minimum tan δ is greater than or equal to 5×10⁵ Pa. The tan δ at the temperature at which the loss modulus (G″) reaches 1×10⁴ Pa is 3.0 or more.

### SUMMARY

In some image forming apparatuses and process cartridges of the related art, supply members for supplying electrostatic image developing toner to electrostatic images are provided in their circumferential surface with a plurality of grooves portions for better holding of developers containing electrostatic image developing toner. Such a supply member having groove portions can hold a developer at the groove portions if the surface roughness of the circumferential surface of the supply member is changed due to, for example, abrasion, and thus can stabilize the amount of transportation of a developer containing electrostatic image developing toner.

However, an electrostatic image developing toner having low viscoelasticity may adhere to the groove portions of the supply member to fill the groove portions, reducing the amount of transported toner. By contrast, an electrostatic image developing toner having high viscoelasticity may tend to crack or chip, thus resulting in the occurrence of color spots in images. This cracking and chipping of toner tend to occur frequently particularly when a developing unit includes a regulating member that regulates the amount of developer on the supply member.

Aspects of non-limiting embodiments of the present disclosure relate to an image forming apparatus and a process cartridge. When the image forming apparatus or the process cartridge is used, the amount of toner transported by a supply member may be stabilized, and the occurrence of color spots in images may be reduced as compared to when an electrostatic image developing toner satisfying (ln η(T1)−ln η(T2))/(T1−T2)>−0.14 or (ln η(T2)−ln η(T3))/(T2−T3)<−0.15 is used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: an image carrier; a charging unit that charges a surface of the image carrier; an electrostatic image forming unit that forms an electrostatic image on the charged surface of the image carrier; a developing unit that includes a container and a supply member and develops the electrostatic image formed on the surface of the image carrier to form a toner image, the container containing an electrostatic image developer that contains an electrostatic image developing toner and a carrier, the supply member having in a circumferential surface thereof a plurality of grooves extending in a direction intersecting a direction of rotation of the supply member, the electrostatic image being developed with the electrostatic image developer; a transfer unit that transfers the toner image formed on the surface of the image carrier to a recording medium; and a fixing unit that fixes the toner image transferred to the recording medium. The electrostatic image developing toner satisfies inequalities below:

(ln η(T1)−ln η(T2))/(T1−T2)≤−0.14

(ln η(T2)−ln η(T3))/(T2−T3)≥−0.15

(ln η(T1)−ln η(T2))/(T1−T2)<(ln η(T2)−ln η(T3))/(T2−T3)

wherein η(T1) represents a viscosity of the electrostatic image developing toner at 60° C., η(T2) represents a viscosity of the electrostatic image developing toner at 90° C., and η(T3) represents a viscosity of the electrostatic image developing toner at 130° C.

### BRIEF DESCRIPTION OF THE DRAWINGS

Exemplary embodiments of the present disclosure will be described in detail based on the following figures, wherein:

FIG. 1 is a schematic diagram illustrating an image forming apparatus according to an exemplary embodiment;

FIG. 2 is a schematic diagram illustrating a process cartridge according to an exemplary embodiment;

FIG. 3 is a sectional view of a developing unit used in an exemplary embodiment; and

FIG. 4 is a sectional view of grooves formed in a surface of a supply member used in an exemplary embodiment and the vicinity of the grooves.

### DETAILED DESCRIPTION

In this specification, if there are two or more substances corresponding to one component in a composition, the amount of the component in the composition refers to the total amount of the two or more substances in the composition, unless otherwise specified.

In this specification, “electrostatic image developing toner” is also referred to simply as “toner”, and “electrostatic image developer” is also referred to simply as “developer”.

Exemplary embodiments of the present disclosure will now be described.

An image forming apparatus according to an exemplary embodiment includes an image carrier; a charging unit that charges a surface of the image carrier; an electrostatic image forming unit that forms an electrostatic image on the charged surface of the image carrier; a developing unit that contains an electrostatic image developer containing an electrostatic image developing toner and a carrier, that includes a supply member that is configured to rotate while holding the electrostatic image developer on a circumferential surface thereof to thereby supply the electrostatic image developing toner to the electrostatic image and that has in the circumferential surface a plurality of grooves extending in a direction intersecting the direction of rotation, and that develops the electrostatic image formed on the surface of the image carrier with the electrostatic image developer to form a toner image; a transfer unit that transfers the toner image formed on the surface of the image carrier to a recording medium; and a fixing unit that fixes the toner image transferred to the recording medium. The electrostatic image developing toner satisfies (ln η(T1)−ln η(T2))/(T1−T2)≤−0.14, (ln η(T2)−ln η(T3))/(T2−T3)≥−0.15, and (ln η(T2)−ln η(T3))/(T2−T3)>(ln η(T1)−ln η(T2))/(T1−T2), wherein η(T1) is a viscosity T of the toner at temperature T1=60° C., η(T2) is a viscosity η of the toner at temperature T2=90° C., and η(T3) is a viscosity η of the toner at temperature T3=130° C.

In the following, the electrostatic image developing toner having the above-described properties is also referred to simply as the “specific toner”. The electrostatic image developing toner contains toner particles.

A process cartridge according to an exemplary embodiment is attachable to and detachable from an image forming apparatus and includes a developing unit that contains an electrostatic image developer containing an electrostatic image developing toner and a carrier, that includes a supply member that is configured to rotate while holding the electrostatic image developer on a circumferential surface thereof to thereby supply the electrostatic image developing toner to an electrostatic image formed on an image carrier and that has in the circumferential surface a plurality of grooves extending in a direction intersecting the direction of rotation, and that develops the electrostatic image formed on the surface of the image carrier with the electrostatic image developer to form a toner image. The electrostatic image developing toner satisfies (ln η(T1)−ln η(T2))/(T1−T2)≤−0.14, (ln η(T2)−ln η(T3))/(T2−T3)≥−0.15, and (ln η(T2)−ln η(T3))/(T2−T3)>(ln η(T1)−ln η(T2))/(T1−T2), wherein η(T1) is a viscosity η of the toner at temperature T1=60° C., η(T2) is a viscosity η of the toner at temperature T2=90° C., and η(T3) is a viscosity 1 of the toner at temperature T3=130° C.

In the image forming apparatus and the process cartridge according to the exemplary embodiments, due to the above configurations, the amount of toner transported by the supply member may be stabilized, and the occurrence of color spots in images may be reduced.

Although the reason is not clear, it is presumed as follows.

First, the properties of the specific toner used in the exemplary embodiments will be described. The above expression (ln η(T1)−ln η(T2))/(T1−T2) indicates the degree of change in viscosity of toner in the temperature range of 60° C. to 90° C., and if this value is −0.14 or less, it means that the toner shows a great change in viscosity in the range of 60° C. to 90° C. The above expression (ln η(T2)−ln η(T3))/(T2−T3) indicates the degree of change in viscosity of toner in the temperature range of 90° C. to 120° C., and if this value is −0.15 or more, and (ln η(T2)−ln η(T3))/(T2−T3) is more than (ln η(T1)−ln η(T2))/(T1−T2), it means that the toner shows a small change in viscosity in the range of 90° C. to 120° C. That is, the specific toner shows an abrupt viscosity change in the range of 60° C. to 90° C. but a small viscosity change in the range of 90° C. to 120° C.

The toner that exhibits such viscosity change properties is probably present, in a binder resin contained in the toner particles, as a low molecular weight component and a high molecular weight component each in an appropriate proportion. That is, the presence of the low molecular weight component in the binder resin increases the likelihood of change in viscosity in the range of 60° C. to 90° C., whereas the presence of the high molecular weight component in the binder resin reduces the likelihood of change in viscosity in the high-temperature range of 90° C. to 120° C.

The specific toner which exhibits the viscosity change properties as described above probably shows a small change in viscosity in the range from room temperature (e.g., 20° C.) to 60° C. and has appropriate viscoelasticity. That is, the presence of the specific toner in the binder resin as a low molecular weight component and a high molecular weight component in appropriate proportions reduces the likelihood of change in viscosity in the range of 60° C. or lower and also maintains the viscoelasticity in the appropriate range. Thus, the specific toner having the above-described properties is unlikely to show a change in viscosity in the range from room temperature to 60° C. and has appropriate viscoelasticity.

As described above, in image forming apparatuses and process cartridges of the related art, the amount of transportation of a developer containing an electrostatic image developing toner can be stabilized by providing a plurality of grooves portions in a circumferential surface of a supply member that supplies the electrostatic image developing toner to an electrostatic image. However, an electrostatic image developing toner having low viscoelasticity may adhere to the groove portions of the supply member to fill the groove portions, reducing the amount of transported toner. By contrast, an electrostatic image developing toner having high viscoelasticity may tend to crack or chip, thus resulting in the occurrence of color spots in images.

In the exemplary embodiments, the specific toner having the above-described properties is used. That is, a toner having appropriate viscoelasticity is used. Thus, adhesion of the toner to the groove portions in the supply member, which might occur if the toner has excessively low viscoelasticity, may be reduced, and the amount of toner transported by the supply member may be stabilized. Furthermore, cracking and chipping of the toner, which might occur if the toner has excessively high viscoelasticity, may be reduced, thus resulting in images with reduced color spots and stabilized image quality.

The members constituting the image forming apparatus according to the exemplary embodiment will now be described in detail.

### Electrostatic Image Developer

First, the electrostatic image developer contained in the developing unit of the image forming apparatus according to the exemplary embodiment will be described.

The electrostatic image developer in the exemplary embodiment at least contains the specific toner. The electrostatic image developer is a two-component developer containing the specific toner and a carrier.

### Electrostatic Image Developing Toner

The details of the specific toner used in the exemplary embodiments will now be described.

### Characteristic Values of Temperature and Viscosity of Toner

The specific toner satisfies the following:

(ln η(T1)−ln η(T2))/(T1−T2)≤−0.14,

(ln η(T2)−ln η(T3))/(T2−T3)≥−0.15, and

(ln η(T2)−ln η(T3))/(T2−T3)>(ln η(T1)−ln η(T2))/(T1−T2),

wherein η(T1) is a viscosity T of the toner at temperature T1=60° C., η(T2) is a viscosity T1 of the toner at temperature T2=90° C., and η(T3) is a viscosity η of the toner at temperature T3=130° C.

In the present disclosure, “ln η(T1)” is the natural logarithm of the viscosity η of the toner at temperature T1=60° C. In η(T1) may be expressed as ln(η(T1)).

In the present disclosure, the unit of the viscosity of the toner is Pa-s, unless otherwise specified.

In the exemplary embodiments, the viscosity of the toner at each temperature is a value determined by the following method.

The loss elastic modulus of the toner in the exemplary embodiments is determined by performing a temperature rise measurement at a frequency of 1 Hz, a strain of 20% or less, a heating rate of 1° C./min from about 30° C. to 150° C., and a sample weight of about 0.3 g using a rotational plate rheometer (RDA2, RHIOS system ver. 4.3, manufactured by Rheometrics, Inc.) with parallel plates 8 mm in diameter.

(ln η(T1)−ln η(T2))/(T1−T2), which is a characteristic value of the specific toner, is −0.14 or less. To stabilize the amount of toner transported by the supply member and reduce the occurrence of color spots in images, this value is preferably −0.16 or less, more preferably −0.30 or more and −0.18 or less, particularly preferably −0.25 or more and −0.20 or less.

(ln η(T2)−ln η(T3))/(T2−T3), which is also a characteristic value of the specific toner, is −0.15 or more. To stabilize the amount of toner transported by the supply member and reduce the occurrence of color spots in images, this value is preferably more than −0.14, more preferably −0.13 or more, still more preferably −0.12 or more and −0.03 or less, particularly preferably −0.11 or more and −0.05 or less.

Furthermore, the specific toner satisfies (ln η(T2)−ln η(T3))/(T2−T3)>(ln η(T1)−ln η(T2))/(T1−T2). To stabilize the amount of toner transported by the supply member and reduce the occurrence of color spots in images, {(ln η(T2)−ln η(T3))/(T2−T3)}−{(ln η(T1)−ln η(T2))/(T1−T2)} is preferably 0.01 or more, more preferably 0.05 or more and 0.5 or less, particularly preferably 0.08 or more and 0.2 or less.

Furthermore, the specific toner preferably satisfies the following:

(ln η(T0)−ln η(T1))/(T0-T1)≥−0.12, and

(ln η(T0)−ln η(T1))/(T0-T1)>(ln η(T1)−ln η(T2))/(T1−T2),

wherein η(T0) is a viscosity η of the toner at temperature T0=40° C.

When the specific toner satisfies (ln η(T0)−ln η(T1))/(T0-T1)≥−0.12, the amount of toner transported by the supply member may be stabilized, and at the same time, the occurrence of color spots tends to be reduced, leading to stable image quality. (ln η(T0)−ln η(T1))/(T0-T1) is more preferably −0.05 or less, particularly preferably −0.11 or more and −0.06 or less.

When the specific toner satisfies (ln η(T0)−ln η(T1))/(T0-T1)>(ln η(T1)−ln η(T2))/(T1−T2), the amount of toner transported by the supply member may be stabilized, and at the same time, the occurrence of color spots tends to be reduced, leading to stable image quality. {(ln η(T0)−ln η(T1))/(T0−T1)}−{(ln η(T1)−ln η(T2))/(T1−T2)} is preferably 0.01 or more, more preferably 0.05 or more and 0.5 or less, particularly preferably 0.08 or more and 0.2 or less.

These characteristic values of temperature and viscosity of the toner, that is, the characteristic values related to (ln η(T1)−ln η(T2))/(T1−T2), (ln η(T2)−ln η(T3))/(T2−T3), and (ln η(T0)−ln η(T1))/(T0-T1) described above can be controlled to be in the above ranges by any method, for example, by adjusting the molecular weight in the binder resin contained in the toner particles, more specifically, by adjusting the molecular weight and content of a low molecular weight component and a high molecular weight component. In the case where the toner particles are produced by aggregation and coalescence described below, the degree of aggregation may be adjusted, for example, by adjusting the amount of aggregating agent added.

To stabilize the amount of toner transported by the supply member and reduce the occurrence of color spots in images, the specific toner may have a viscosity η(T0) at temperature T0=40° C., a viscosity η(T1) at temperature T1=60° C., a viscosity η(T2) at temperature T2=90C, and a viscosity η(T3) at temperature T3=130° C. in the following ranges.

η(T0): 1.0×10⁷ or more and 1.0×10⁹ or less (more preferably 2.0×10⁷ or more and 5.0×10⁸ or less)

η(T1): 1.0×10⁵ or more and 1.0×10⁸ or less (more preferably 1.0×10⁶ or more and 5.0×10⁷ or less)

η(T2): 1.0×10³ or more and 1.0×10⁵ or less (more preferably 5.0×10³ or more and 5.0×10⁴ or less)

η(T3): 1.0×10² or more and 1.0×10⁴ or less (more preferably 1.0×10² or more and 5.0×10³ or less)

### Maximum Endothermic Peak Temperature of Toner

The maximum endothermic peak temperature of the specific toner is preferably 70° C. or higher and 100° C. or lower, more preferably 75° C. or higher and 95° C. or lower, particularly preferably 83° C. or higher and 93° C. or lower.

The maximum endothermic peak temperature of the specific toner is a temperature that gives a maximum endothermic peak in an endothermic curve including at least the range of from −30° C. to 150° C. obtained by differential scanning calorimetry.

A method for measuring the maximum endothermic peak temperature of the specific toner will be described below.

The method uses a DSC-7 differential scanning calorimeter manufactured by PerkinElmer Inc. Temperature correction of a detector of the device is performed using the melting points of indium and zinc, and correction of heat quantity is performed using the heat of fusion of indium. An aluminum pan is used as a sample pan, and an empty pan is set as a reference. The temperature is increased from room temperature to 150° C. at a heating rate of 10° C./min, decreased from 150° C. to −30° C. at a rate of 10° C./min, and then increased from −30° C. to 150° C. at a rate of 10° C./min. The temperature at the highest endothermic peak in the second heating process is used as the maximum endothermic peak temperature.

### Infrared Absorption Spectrum of Toner Particles

When the specific toner contains an amorphous polyester resin described below as a binder resin, to stabilize the amount of toner transported by the supply member and reduce the occurrence of color spots in images, the ratio of an absorbance at a wave number of 1,500 cm⁻¹ to an absorbance at a wave number of 720 cm⁻¹ (absorbance at wave number of 1,500 cm⁻¹/absorbance at wave number of 720 cm⁻¹) is preferably 0.6 or less, and the ratio of an absorbance at a wave number of 820 cm⁻¹ to an absorbance at a wave number of 720 cm⁻¹ (absorbance at wave number of 820 cm⁻¹/absorbance at wave number of 720 cm⁻¹) is preferably 0.4 or less in infrared absorption spectrum analysis of the toner particles. More preferably, the ratio of an absorbance at a wave number of 1,500 cm⁻¹ to an absorbance at a wave number of 720 cm⁻¹ is 0.4 or less, and the ratio of an absorbance at a wave number of 820 cm⁻¹ to an absorbance at a wave number of 720 cm⁻¹ is 0.2 or less in infrared absorption spectrum analysis of the toner particles. Particularly preferably, the ratio of an absorbance at a wave number of 1,500 cm⁻¹ to an absorbance at a wave number of 720 cm⁻¹ is 0.2 or more and 0.4 or less, and the ratio of an absorbance at a wave number of 820 cm⁻¹ to an absorbance at a wave number of 720 cm⁻¹ is 0.05 or more and 0.2 or less in infrared absorption spectrum analysis of the toner particles.

The measurement of the absorbance at the predetermined wave numbers by infrared absorption spectrum analysis in the exemplary embodiments is carried out by the method described below. First, a test sample is prepared from target toner particles (toner from which external additives are removed as required) by using the KBr pellet method. The test sample is then measured using an infrared spectrophotometer (FT-IR-410 manufactured by JASCO Corporation) in the wave number range of 500 cm-1 to 4,000 cm⁻¹ under the following conditions: the number of scans, 300; resolution, 4 cm⁻¹. Baseline correction is performed, for example, in an offset region where no light is absorbed, and the absorbance at the predetermined wave numbers is determined.

To stabilize the amount of toner transported by the supply member and reduce the occurrence of color spots in images, the ratio of an absorbance at a wave number of 1,500 cm⁻¹ to an absorbance at a wave number of 720 cm⁻¹ in infrared absorption spectrum analysis of the toner particles in the specific toner is preferably 0.6 or less, more preferably 0.4 or less, still more preferably 0.2 or more and 0.4 or less, particularly preferably 0.3 or more and 0.4 or less.

To stabilize the amount of toner transported by the supply member and reduce the occurrence of color spots in images, the ratio of an absorbance at a wave number of 820 cm⁻¹ to an absorbance at a wave number of 720 cm⁻¹ in infrared absorption spectrum analysis of the toner particles in the specific toner is preferably 0.4 or less, more preferably 0.2 or less, still more preferably 0.05 or more and 0.2 or less, particularly preferably 0.08 or more and 0.2 or less.

### Toner Particles

The toner particles contain, for example, a binder resin and optionally a coloring agent, a release agent, and other additives. Preferably, the toner particles contain a binder resin and a release agent.

In the exemplary embodiments, the toner particles may be, for example, but not limited to, toner particles of yellow toner, magenta toner, cyan toner, or black toner, white toner particles, transparent toner particles, or photoluminescent toner particles.

### Binder Resin

Examples of binder resins include vinyl resins made of homopolymers of monomers such as styrenes (e.g., styrene, p-chlorostyrene, and α-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene); and vinyl resins made of copolymers of two or more of these monomers.

Other examples of binder resins include non-vinyl resins such as epoxy resins, polyester resins, polyurethane resins, polyamide resins, cellulose resins, polyether resins, and modified rosins; mixtures of these non-vinyl resins and the above vinyl resins; and graft polymers obtained by polymerization of vinyl monomers in the presence of these non-vinyl resins.

These binder resins may be used alone or in combination.

To stabilize the amount of toner transported by the supply member and reduce the occurrence of color spots in images, the binder resin preferably contains at least one selected from the group consisting of styrene-acrylic resins and amorphous polyester resins, more preferably contains a styrene-acrylic resin or an amorphous polyester resin.

Still more preferably, the styrene-acrylic resin or amorphous polyester resin is contained in an amount of 50 mass % or more based on the total mass of the binder resin contained in the toner. Particularly preferably, the styrene-acrylic resin or amorphous polyester resin is contained in an amount of 80 mass % or more based on the total mass of the binder resin contained in the toner.

In view of the strength and storage stability of the toner, the specific toner may contain a styrene-acrylic resin as the binder resin.

In view of low-temperature fixability, the specific toner may contain an amorphous polyester resin as the binder resin.

To stabilize the amount of toner transported by the supply member and reduce the occurrence of color spots in images, and in view of fixability, the amorphous polyester resin may be an amorphous polyester resin having no bisphenol structures.

### (1) Styrene-Acrylic Resin

The binder resin may be a styrene-acrylic resin.

The styrene-acrylic resin is a copolymer of at least a styrene monomer (a monomer having a styrene backbone) and a (meth)acrylic monomer (a monomer having a (meth)acrylic group, preferably a monomer having a (meth)acryloxy group). The styrene-acrylic resin contains, for example, a copolymer of a monomer of a styrene and a monomer of any one of the above (meth)acrylates.

The acrylic resin moiety in the styrene-acrylic resin is a substructure formed by polymerization of one or both of an acrylic monomer and a methacrylic monomer. The expression “(meth)acrylic” is meant to include both “acrylic” and “methacrylic”.

Specific examples of styrene monomers include styrene, alkyl-substituted styrenes (e.g., α-methylstyrene, 2-methylstyrene, 3-methylstyrene, 4-methylstyrene, 2-ethylstyrene, 3-ethylstyrene, and 4-ethylstyrene), halogen-substituted styrenes (e.g., 2-chlorostyrene, 3-chlorostyrene, and 4-chlorostyrene), and vinylnaphthalene. These styrene monomers may be used alone or in combination.

Of these styrene monomers, styrene is preferred for its ease of reaction, ease of reaction control, and availability.

Specific examples of (meth)acrylic monomers include (meth)acrylic acid and (meth)acrylates. Examples of (meth)acrylates include alkyl (meth)acrylates (e.g., methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), aryl (meth)acrylates (e.g., phenyl (meth)acrylate, biphenyl (meth)acrylate, diphenylethyl (meth)acrylate, t-butylphenyl (meth)acrylate, and terphenyl (meth)acrylate), dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, and (meth)acrylamides. These (meth)acrylate monomers may be used alone or in combination.

Of these (meth)acrylates among the (meth)acrylic monomers, (meth)acrylates having an alkyl group having 2 to 14 (preferably 2 to 10, more preferably 3 to 8) carbon atoms are preferred in terms of fixability.

In particular, n-butyl (meth)acrylate is preferred, and n-butyl acrylate is particularly preferred.

The copolymerization ratio (by mass) of the styrene monomer to the (meth)acrylic monomer (styrene monomer/(meth)acrylic monomer) is preferably, but not necessarily, 85/15 to 70/30.

To stabilize the amount of toner transported by the supply member and reduce the occurrence of color spots in images, the styrene-acrylic resin may have a crosslinked structure. The styrene-acrylic resin having a crosslinked structure may be, for example, a copolymer of at least a styrene monomer, a (meth)acrylate monomer, and a crosslinkable monomer.

Examples of crosslinkable monomers include bi- or more functional cross-linking agents.

Examples of bifunctional cross-linking agents include divinylbenzene, divinylnaphthalene, di(meth)acrylate compounds (e.g., diethylene glycol di(meth)acrylate, methylenebis(meth)acrylamide, decanediol diacrylate, and glycidyl (meth)acrylate), polyester di(meth)acrylates, and 2-([1′-methylpropylideneamino]carboxyamino) ethyl (meth)acrylate.

Examples of polyfunctional crosslinking agents include tri(meth)acrylate compounds (e.g., pentaerythritol tri(meth)acrylate, trimethylolethane tri(meth)acrylate, and trimethylolpropane tri(meth)acrylate), tetra(meth)acrylate compounds (e.g., pentaerythritol tetra(meth)acrylate and oligoester (meth)acrylates), 2,2-bis(4-methacryloxypolyethoxyphenyl) propane, diallyl phthalate, triallyl cyanurate, triallyl isocyanurate, triallyl trimellitate, and diallyl chlorendate.

To stabilize the amount of toner transported by the supply member and reduce the occurrence of color spots in images, the crosslinkable monomer is preferably a bi- or more functional (meth)acrylate compound, more preferably a bifunctional (meth)acrylate compound, still more preferably a bifunctional (meth)acrylate compound having an alkylene group having 6 to 20 carbon atoms, particularly preferably a bifunctional (meth)acrylate compound having a linear alkylene group having 6 to 20 carbon atoms.

The copolymerization ratio (by mass) of the crosslinkable monomer to all monomers (crosslinkable monomer/all monomers) is preferably, but not necessarily, 2/1,000 to 20/1,000.

In view of fixability, the glass transition temperature (Tg) of the styrene-acrylic resin is preferably 40° C. or higher and 75° C. or lower, more preferably 50° C. or higher and 65° C. or lower.

The glass transition temperature is determined from a DSC curve obtained by differential scanning calorimetry (DSC). More specifically, the glass transition temperature is determined in accordance with “Extrapolation Glass Transition Onset Temperature” described in Determination of Glass Transition Temperature in JIS K 7121-1987 “Testing Methods for Transition Temperatures of Plastics”.

In view of storage stability, the weight average molecular weight of the styrene-acrylic resin is preferably 5,000 or more and 200,000 or less, more preferably 10,000 or more and 100,000 or less, particularly preferably 20,000 or more and 80,000 or less.

The styrene-acrylic resin may be produced by any method, and various polymerization methods (e.g., solution polymerization, precipitation polymerization, suspension polymerization, bulk polymerization, and emulsion polymerization) may be used. The polymerization reaction is carried out by using a known process (e.g., a batch process, a semi-continuous process, or a continuous process).

### (2) Polyester Resin

The binder resin may be a polyester resin.

Examples of polyester resins include known amorphous polyester resins. The polyester resin may be a combination of an amorphous polyester resin with a crystalline polyester resin. The crystalline polyester resin may be present in an amount of 2 mass % or more and 40 mass % or less (preferably 2 mass % or more and 20 mass % or less) based on the total mass of the binder resin.

“Crystalline” in the context of a resin means that the resin shows a distinct endothermic peak, rather than a stepwise change in the amount of heat absorbed, in differential scanning calorimetry (DSC). Specifically, it means that the half-width of the endothermic peak measured at a heating rate of 10° C./min is within 10° C.

“Amorphous” in the context of a resin means that the half-width exceeds 10° C., that a stepwise change in the amount of heat absorbed is shown, or that no distinct endothermic peak is observed.

### Amorphous Polyester Resin

Examples of amorphous polyester resins include polycondensates of polycarboxylic acids with polyhydric alcohols. The amorphous polyester resin for use may be a commercially available product or may be synthesized.

Examples of polycarboxylic acids include aliphatic dicarboxylic acids (e.g., oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, and lower (e.g., C1 to C5) alkyl esters thereof. Of these, aromatic dicarboxylic acids are preferred, for example.

The polycarboxylic acid may be a combination of a dicarboxylic acid with a trivalent or higher valent carboxylic acid having a crosslinked or branched structure. Examples of trivalent or higher valent carboxylic acids include trimellitic acid, pyromellitic acid, anhydrides thereof, and lower (e.g., C1 to C5) alkyl esters thereof.

These polycarboxylic acids may be used alone or in combination.

Examples of polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these, aromatic diols and alicyclic diols are preferred, and aromatic diols are more preferred.

The polyhydric alcohol may be a combination of a diol with a trivalent or higher valent polyhydric alcohol having a crosslinked or branched structure. Examples of trivalent or higher valent polyhydric alcohols include glycerol, trimethylolpropane, and pentaerythritol.

These polyhydric alcohols may be used alone or in combination.

The glass transition temperature (Tg) of the amorphous polyester resin is preferably 50° C. or higher and 80° C. or lower, more preferably 50° C. or higher and 65° C. or lower.

The glass transition temperature is determined from a DSC curve obtained by differential scanning calorimetry (DSC). More specifically, the glass transition temperature is determined in accordance with “Extrapolation Glass Transition Onset Temperature” described in Determination of Glass Transition Temperature in JIS K 7121-1987 “Testing Methods for Transition Temperatures of Plastics”.

The weight average molecular weight (Mw) of the amorphous polyester resin is preferably 5,000 or more and 1,000,000 or less, more preferably 7,000 or more and 500,000 or less.

The number average molecular weight (Mn) of the amorphous polyester resin is preferably 2,000 or more and 100,000 or less.

The molecular weight distribution Mw/Mn of the amorphous polyester resin is preferably 1.5 or more and 100 or less, more preferably 2 or more and 60 or less.

The weight average molecular weight and the number average molecular weight are determined by gel permeation chromatography (GPC). The molecular weight determination by GPC is performed using an HLC-8120GPC system manufactured by Tosoh Corporation as a measurement apparatus, a TSKgel SuperHM-M column (15 cm) manufactured by Tosoh Corporation, and a THF solvent. The weight average molecular weight and the number average molecular weight are determined using a molecular weight calibration curve prepared from the measurement results relative to monodisperse polystyrene standards.

The amorphous polyester resin may be produced by a known process. Specifically, the amorphous resin may be produced, for example, by performing a polymerization reaction at a temperature of 180° C. to 230° C., optionally while removing water and alcohol produced during condensation by reducing the pressure in the reaction system.

If any starting monomer is insoluble or incompatible at the reaction temperature, it may be dissolved by adding a high-boiling solvent as a solubilizer. In this case, the polycondensation reaction is performed while distilling off the solubilizer. If the copolymerization reaction is performed using a poorly compatible monomer, the poorly compatible monomer may be condensed with an acid or alcohol to be polycondensed with the monomer before being polycondensed with the major components.

### Crystalline Polyester Resin

Examples of crystalline polyester resins include polycondensates of polycarboxylic acids with polyhydric alcohols. The crystalline polyester resin for use may be a commercially available product or may be synthesized.

To easily form a crystalline structure, the crystalline polyester resin may be a polycondensate prepared from linear aliphatic polymerizable monomers rather than from aromatic polymerizable monomers.

Examples of polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids such as phthalic acid, isophthalic acid, terephthalic acid, and naphthalene-2,6-dicarboxylic acid), anhydrides thereof, and lower (e.g., C1 to C5) alkyl esters thereof.

The polycarboxylic acid may be a combination of a dicarboxylic acid with a trivalent or higher valent carboxylic acid having a cross-linked or branched structure. Examples of tricarboxylic acids include aromatic carboxylic acids (e.g., 1,2,3-benzenetricarboxylic acid, 1,2,4-benzenetricarboxylic acid, and 1,2,4-naphthalenetricarboxylic acid), anhydrides thereof, and lower (e.g., C1 to C5) alkyl esters thereof.

The polycarboxylic acid may be a combination of such a dicarboxylic acid with a dicarboxylic acid having a sulfonic group or a dicarboxylic acid having an ethylenic double bond.

These polycarboxylic acids may be used alone or in combination.

Examples of polyhydric alcohols include aliphatic diols (e.g., linear aliphatic diols having 7 to 20 main-chain carbon atoms). Examples of aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these, 1,8-octanediol, 1,9-nonanediol, and 1,10-decanediol are preferred.

The polyhydric alcohol may be a combination of a diol with a trivalent or higher valent alcohol having a cross-linked or branched structure. Examples of trivalent or higher valent alcohols include glycerol, trimethylolethane, trimethylolpropane, and pentaerythritol.

These polyhydric alcohols may be used alone or in combination.

The amount of aliphatic diol in the polyhydric alcohol may be 80 mol % or more and is preferably 90 mol % or more.

The melting temperature of the crystalline polyester resin is preferably 50° C. or higher and 100° C. or lower, more preferably 55° C. or higher and 90° C. or lower, still more preferably 60° C. or higher and 85° C. or lower.

The melting temperature is determined from a DSC curve obtained by differential scanning calorimetry (DSC) in accordance with “Melting Peak Temperature” described in Determination of Melting Temperature of JIS K 7121-1987 “Testing Methods for Transition Temperatures of Plastics”.

The weight average molecular weight (Mw) of the crystalline polyester resin is preferably 6,000 or more and 35,000 or less.

The crystalline polyester resin may be produced, for example, by a known method, as with the amorphous polyester resin.

For example, the amount of binder resin is preferably 40 mass % or more and 95 mass % or less, more preferably 50 mass % or more and 90 mass % or less, still more preferably 60 mass % or more and 85 mass % or less, based on the total mass of the toner particles.

The amount of binder resin in the case where the toner particles are white toner particles is preferably 30 mass % or more and 85 mass % or less, more preferably 40 mass % or more and 60 mass % or less, based on the total mass of the white toner particles.

### Coloring Agent

Examples of coloring agents include various pigments such as carbon black, chromium yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, malachite green oxalate, titanium oxide, zinc oxide, calcium carbonate, basic lead carbonate, zinc sulfide-barium sulfate mixtures, zinc sulfide, silicon dioxide, and aluminum oxide; and various dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

When the toner particles are white toner particles, a white pigment is used as a coloring agent.

The white pigment is preferably titanium oxide or zinc oxide, more preferably titanium oxide.

The above coloring agents may be used alone or in combination.

Optionally, the coloring agent may be a surface-treated coloring agent or may be used in combination with a dispersant. The coloring agent may be a combination of different coloring agents.

For example, the amount of coloring agent is preferably 1 mass % or more and 30 mass % or less, more preferably 3 mass % or more and 15 mass % or less, based on the total mass of the toner particles.

When the toner particles are white toner particles, the amount of white pigment is preferably 15 mass % or more and 70 mass % or less, more preferably 20 mass % or more and 60 mass % or less, based on the total mass of the white toner particles.

### Release Agent

Examples of release agents include hydrocarbon waxes; natural waxes such as carnauba wax, rice wax, and Candelilla wax; synthetic, mineral, and petroleum waxes such as montan wax; and ester waxes such as fatty acid esters and montanic acid esters, but are not limited thereto.

To stabilize the amount of toner transported by the supply member and reduce the occurrence of color spots in images, the melting temperature of the release agent is preferably 50° C. or higher and 110° C. or lower, more preferably 70° C. or higher and 100° C. or lower, still more preferably 75° C. or higher and 95° C. or lower, particularly preferably 83° C. or higher and 93° C. or lower.

The melting temperature is determined from a DSC curve obtained by differential scanning calorimetry (DSC) in accordance with “Melting Peak Temperature” described in Determination of Melting Temperature of JIS K 7121-1987 “Testing Methods for Transition Temperatures of Plastics”.

To stabilize the amount of toner transported by the supply member and reduce the occurrence of color spots in images, the toner particles in the specific toner preferably satisfy 1.0<a/b<8.0, more preferably satisfy 2.0<a/b<7.0, particularly preferably satisfy 3.0<a/b<6.0, wherein a is the number of domains formed of the release agent and having an aspect ratio of 5 or more in the toner, and b is the number of domains formed of the release agent and having an aspect ratio of less than 5 in the toner.

To stabilize the amount of toner transported by the supply member and reduce the occurrence of color spots in images, the toner particles in the specific toner preferably satisfy 1.0<c/d<4.0, more preferably satisfy 1.5<c/d<3.5, particularly preferably satisfy 2.0<c/d<3.0, wherein c is the area of domains formed of the release agent and having an aspect ratio of 5 or more in the toner, and d is the area of domains formed of the release agent and having an aspect ratio of less than 5 in the toner.

The aspect ratio of domains formed of the release agent in the toner is determined by the following method.

The toner is mixed with epoxy resin, and the epoxy resin is cured. The resulting cured resin is sliced with an ultramicrotome (ULTRACUT UCT manufactured by Leica Microsystems) to prepare a sample section having a thickness of 80 nm or more and 130 nm or less. Next, the sample section is stained with ruthenium tetroxide in a desiccator at 30° C. for 3 hours. An SEM image of the stained sample section is captured under a super-resolution field-emission scanning electron microscope (FE-SEM) (e.g., S-4800 manufactured by Hitachi High-Technologies Corporation). In general, release agents are more easily stained with ruthenium tetroxide than binder resins, and thus the release agent is distinguished by the density depending on the degree of staining. If the density is difficult to determine, for example, because of the sample condition, the staining time is adjusted. The release agent is distinguishable by its size because coloring agent domains are generally smaller than release agent domains in a toner particle section.

The SEM image includes toner particle sections with various sizes. Toner particle sections having a diameter larger than or equal to 85% of the volume average particle size of the toner particles are selected. From these sections, 100 toner particle sections are randomly selected and observed. The diameter of a toner particle section is a maximum length (i.e., a major axis) between any two points on the contour of the toner particle section.

Each of the 100 toner particle sections selected as described above in the SEM image is subjected to image analysis using image analysis software (WINROOF available from Mitani Corporation) under the condition of 0.010000 m/pixel. This image analysis allows the images of the toner particle sections to be observed based on the difference in brightness (contrast) between the epoxy resin used for embedding and the binder resin in the toner particles. The length along the major axis, the ratio (length along major axis/length along minor axis), and the area of release agent domains in the toner particles can be determined based on the observed image.

The aspect ratio of domains formed of the release agent in the toner can be controlled, for example, by maintaining the temperature, during cooling, at around the freezing point of the release agent for a given period of time to grow crystals or by using two or more release agents having different melting temperatures to facilitate the crystal growth during cooling.

For example, the amount of release agent is preferably 1 mass % or more and 20 mass % or less, more preferably 5 mass % or more and 15 mass % or less, based on the total mass of the toner particles.

### Other Additives

Examples of other additives include known additives such as magnetic materials, charge control agents, and inorganic powders. These additives are contained as internal additives in the toner particles.

### Properties of Toner Particles

The toner particles may be toner particles having a single-layer structure or toner particles having, what is called, a core shell structure composed of a core (core particle) and a coating layer (shell layer) covering the core.

The toner particles having a core shell structure may be composed of, for example, a core and a coating layer, the core containing a binder resin and other optional additives such as a coloring agent and a release agent, the coating layer containing a binder resin.

The volume average particle size (D50v) of the toner particles is preferably 2 μm or more and 10 μm or less, more preferably 4 μm or more and 8 μm or less.

The volume average particle size of the toner particles is measured using a COULTER MULTISIZER II (manufactured by Beckman Coulter, Inc.) and ISOTON-II electrolyte solution (manufactured by Beckman Coulter, Inc.).

In the measurement, 0.5 mg to 50 mg of a test sample is added to 2 ml of a 5 mass % aqueous solution of a surfactant (e.g., sodium alkylbenzene sulfonate) serving as a dispersant. The resulting solution is added to 100 ml to 150 ml of the electrolyte solution.

The electrolyte solution containing the suspended sample is dispersed with a sonicator for 1 minute, and the particle size distribution of particles having particle sizes in the range of from 2 μm to 60 μm is measured with the COULTER MULTISIZER II using an aperture having an aperture diameter of 100 m. The number of sampled particles is 50,000.

The particle size distribution obtained is divided into particle size classes (channels). A cumulative volume distribution is drawn from smaller particle sizes. The volume average particle size D50v is defined as the particle size at which the cumulative volume is 50%.

The average circularity of the toner particles is not limited to a particular value but is preferably 0.91 or more and 0.98 or less, more preferably 0.94 or more and 0.98 or less, still more preferably 0.95 or more and 0.97 or less, for improved cleaning of the toner off the image carrier.

The average circularity of the toner particles is determined by (perimeter of equivalent circle)/(perimeter) [(perimeter of circle having same projected area as that of particle image)/(perimeter of projected particle image)]. Specifically, the average circularity is measured by the following method.

Target toner particles are collected by suction so as to form a flat flow, and strobe light is flashed to capture a still particle image. The particle image is analyzed with a flow particle image analyzer (FPIA-3000 manufactured by Sysmex Corporation). The number of particles sampled for determining the average circularity is 3,500.

When the toner contains an external additive, the toner (developer) to be measured is dispersed in water containing a surfactant and then sonicated to obtain toner particles from which the external additive has been removed.

For example, when the toner particles are produced by aggregation and coalescence, the average circularity of the toner particles can be controlled by adjusting the rate of stirring a dispersion, the temperature of the dispersion, or the retention time in a fusion and coalescence step.

External additive Examples of external additives include inorganic particles. Examples of inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surface of inorganic particles used as an external additive may be subjected to hydrophobic treatment. The hydrophobic treatment may be performed, for example, by immersing the inorganic particles in a hydrophobic agent. Non-limiting examples of hydrophobic agents include silane coupling agents, silicone oil, titanate coupling agents, and aluminum coupling agents. These hydrophobic agents may be used alone or in combination.

The amount of hydrophobic agent is typically, for example, 1 part by mass or more and 10 parts by mass or less based on 100 parts by mass of the inorganic particles.

Other examples of external additives include resin particles (particles of resins such as polystyrene, polymethyl methacrylate (PMMA), and melamine resins) and cleaning active agents (e.g., particles of higher fatty acid metal salts such as zinc stearate, and fluoropolymer particles).

For example, the amount of external additive added is preferably 0.01 mass % or more and 10 mass % or less, more preferably 0.01 mass % or more and 6 mass % or less, based on the amount of toner particles.

### Method for Producing Toner

Next, a method for producing the specific toner will be described.

The specific toner is obtained by producing toner particles and then adding an external additive to the toner particles.

The toner particles may be produced by a dry process (e.g., kneading pulverization) or a wet process (e.g., aggregation and coalescence, suspension polymerization, or dissolution suspension). Not only these processes but any known process may be used to produce the toner particles.

Of these, aggregation and coalescence may be used to obtain the toner particles.

Specifically, for example, when the toner particles are produced by aggregation and coalescence, they are produced by the following steps:

a step (a resin particle dispersion preparing step) of preparing a resin particle dispersion in which resin particles serving as a binder resin are dispersed; a step (an aggregate particle forming step) of aggregating the resin particles (optionally, other particles) in the resin particle dispersion (optionally, a dispersion mixture with another particle dispersion) to form aggregate particles; and a step (a fusion and coalescence step) of heating the aggregate particle dispersion, in which the aggregate particles are dispersed, to fuse and coalesce the aggregate particles, thereby forming toner particles.

The steps will be described below in detail.

Although a method for producing toner particles containing a coloring agent and a release agent will be described below, the coloring agent and the release agent are optional. It should be understood that additives other than coloring agents and release agents may also be used.

Resin particle dispersion preparing step First, a resin particle dispersion in which resin particles serving as a binder resin are dispersed as well as, for example, a coloring agent particle dispersion in which coloring agent particles are dispersed and a release agent particle dispersion in which release agent particles are dispersed are prepared.

The resin particle dispersion is prepared, for example, by dispersing resin particles in a dispersion medium with a surfactant.

Examples of dispersion media used to prepare the resin particle dispersion include aqueous media.

Examples of aqueous media include water, such as distilled water and ion-exchanged water, and alcohols. These aqueous media may be used alone or in combination.

Examples of surfactants include anionic surfactants such as sulfate ester salts, sulfonate salts, phosphate esters, and soaps; cationic surfactants such as amine salts and quaternary ammonium salts; and nonionic surfactants such as polyethylene glycol, alkylphenol-ethylene oxide adducts, and polyhydric alcohols. Of these, anionic surfactants and cationic surfactants are particularly preferred. Nonionic surfactants may be used in combination with an anionic surfactant or a cationic surfactant.

These surfactants may be used alone or in combination.

In preparing the resin particle dispersion, the resin particles may be dispersed in a dispersion medium by any commonly-used dispersion technique, for example, a rotary shear homogenizer or a media mill such as a ball mill, a sand mill, or a Dyno-Mill. Depending on the type of resin particles, the resin particles may be dispersed in the resin particle dispersion, for example, by phase-inversion emulsification.

Phase-inversion emulsification is a process involving dissolving a resin of interest in a hydrophobic organic solvent capable of dissolving the resin, neutralizing the organic continuous phase (O-phase) by adding a base thereto, and then adding an aqueous medium (W-phase) to cause inversion (i.e., phase inversion) of the resin from W/O to O/W and form a discontinuous phase, thereby dispersing the resin in the form of particles in the aqueous medium.

The volume average particle size of the resin particles dispersed in the resin particle dispersion is, for example, preferably 0.01 μm or more and 1 μm or less, more preferably 0.08 μm or more and 0.8 μm or less, still more preferably 0.1 μm or more and 0.6 μm or less.

The volume average particle size of the resin particles is determined as follows. A particle size distribution is obtained using a laser diffraction particle size distribution analyzer (e.g., LA-700 manufactured by Horiba, Ltd.) and is divided into particle size classes (channels). A cumulative volume distribution is drawn from smaller particle sizes. The volume average particle size D50v is measured as the particle size at which the cumulative volume is 50% of all particles. The volume average particle sizes of particles in other dispersions are determined in the same manner.

For example, the amount of resin particles contained in the resin particle dispersion is preferably 5 mass % or more and 50 mass % or less, more preferably 10 mass % or more and 40 mass % or less.

The coloring agent particle dispersion and the release agent particle dispersion are prepared in the same manner as the resin particle dispersion. That is, the volume average particle size of particles, the dispersion medium, the dispersion technique, and the amount of particles for the resin particle dispersion are also applied to coloring agent particles dispersed in the coloring agent particle dispersion and release agent particles dispersed in the release agent particle dispersion.

### Aggregate Particle Forming Step

Next, the resin particle dispersion is mixed with the coloring agent particle dispersion and the release agent particle dispersion.

The resin particles, the coloring agent particles, and the release agent particles are then allowed to undergo heteroaggregation in the mixed dispersion to form aggregate particles including the resin particles, the coloring agent particles, and the release agent particle. The aggregate particles have a particle size close to that of the desired toner particles.

Specifically, the aggregate particles are formed, for example, by adding an aggregating agent to the mixed dispersion while adjusting the mixed dispersion to an acidic pH (e.g., a pH of 2 to 5), optionally adding a dispersion stabilizer, and then heating the mixed dispersion to aggregate the particles dispersed therein. The mixed dispersion is heated to a temperature close to the glass transition temperature of the resin particles (e.g., 10° C. to 30° C. lower than the glass transition temperature of the resin particles).

For example, the aggregate particle forming step may be performed by adding an aggregating agent to the mixed dispersion at room temperature (e.g., 25° C.) with stirring using a rotary shear homogenizer, adjusting the mixed dispersion to an acidic pH (e.g., a pH of 2 to 5), optionally adding a dispersion stabilizer, and then heating the mixed dispersion.

Examples of aggregating agents include surfactants having polarity opposite to that of the surfactant used as a dispersant added to the mixed dispersion, inorganic metal salts, and metal complexes with a valence of two or more. In particular, the use of a metal complex as the aggregating agent may reduce the amount of surfactant used, which may improve the charging characteristics.

Additives that form a complex or a similar linkage together with metal ions of the aggregating agent may optionally be used. Examples of such additives include chelating agents.

Examples of inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent may be a water-soluble chelating agent. Examples of chelating agents include oxycarboxylic acids such as tartaric acid, citric acid, and gluconic acid; iminodiacetic acid (IDA); nitrilotriacetic acid (NTA); and ethylenediaminetetraacetic acid (EDTA).

For example, the amount of chelating agent added is preferably 0.01 parts by mass or more and 5.0 parts by mass or less, more preferably 0.1 parts by mass or more and less than 3.0 parts by mass, based on 100 parts by mass of the resin particles.

### Fusion and Coalescence Step

Next, the aggregate particle dispersion in which the aggregate particles are dispersed is heated, for example, at or above the glass transition temperature of the resin particles (e.g., 10° C. to 30° C. higher than the glass transition temperature of the resin particles) to fuse and coalesce the aggregate particles, thereby forming toner particles.

Alternatively, the aggregate particle dispersion may be heated at or above the melting temperature of the release agent to fuse and coalesce the aggregate particles, thereby forming toner particles. In the fusion and coalescence step, the resin and the release agent are in a molten state at or above the glass transition temperature of the resin particles and at or above the melting temperature of the release agent. Thereafter, cooling is performed to obtain a toner.

The aspect ratio of domains formed of the release agent in the toner can be controlled, for example, by maintaining the temperature, during cooling, at around the freezing point of the release agent for a given period of time to grow crystals or by using two or more release agents having different melting temperatures to facilitate the crystal growth during cooling.

Through the above steps, toner particles are obtained.

The toner particles may also be produced through a step of, after preparing the aggregate particle dispersion in which the aggregate particles are dispersed, further mixing the aggregate particle dispersion with a resin particle dispersion in which resin particles are dispersed and aggregating the resin particles such that the resin particles adhere to the surface of the aggregate particles to form second aggregate particles; and a step of fusing and coalescing the second aggregate particles by heating the second aggregate particle dispersion in which the second aggregate particles are dispersed to form toner particles having a core shell structure.

After the completion of the fusion and coalescence step, the toner particles formed in the solution are subjected to known washing, solid-liquid separation, and drying steps to obtain dry toner particles.

The washing step may be performed by sufficient displacement washing with ion-exchanged water in terms of charging characteristics. Although the solid-liquid separation step may be performed by any process, processes such as suction filtration and pressure filtration may be used in terms of productivity. Although the drying step may be performed by any process, processes such as freeze drying, flash drying, fluidized bed drying, and vibrating fluidized bed drying may be used in terms of productivity.

The specific toner is produced, for example, by adding an external additive to the dry toner particles obtained and mixing them together. The mixing may be performed, for example, with a V-blender, a HENSCHEL mixer, or a Loedige mixer. Optionally, coarse toner particles may be removed using, for example, a vibrating screen or an air screen.

### Carrier

The carrier may be any known carrier. Examples of carriers include coated carriers obtained by coating the surface of cores formed of magnetic powders with coating resins; magnetic-powder-dispersed carriers obtained by dispersing and blending magnetic powders in matrix resins; and resin-impregnated carriers obtained by impregnating porous magnetic powders with resins.

The magnetic-powder-dispersed carriers and the resin-impregnated carriers may also be carriers obtained by using the constituent particles of the carriers as cores and coating the cores with coating resins.

Examples of magnetic powders include magnetic metals such as iron, nickel, and cobalt and magnetic oxides such as ferrite and magnetite.

Examples of coating resins and matrix resins include polyethylene, polypropylene, polystyrene, polyvinyl acetate, polyvinyl alcohol, polyvinyl butyral, polyvinyl chloride, polyvinyl ethers, polyvinyl ketones, vinyl chloride-vinyl acetate copolymers, styrene-acrylate copolymers, straight silicone resins containing organosiloxane bonds and modified products thereof, fluorocarbon resins, polyesters, polycarbonates, phenolic resins, and epoxy resins.

The coating resins and the matrix resins may contain conductive particles and other additives.

Examples of conductive particles include particles of metals such as gold, silver, and copper, carbon black, titanium oxide, zinc oxide, tin oxide, barium sulfate, aluminum borate, and potassium titanate.

An example method for coating the surface of the core with the coating resin is coating with a solution for coating layer formation obtained by dissolving the coating resin and various optional additives in an appropriate solvent. Any solvent may be selected by taking into account factors such as the coating resin used and coating suitability.

Specific methods for coating the core with the coating resin include a dipping method in which the core is dipped in the solution for coating layer formation, a spraying method in which the surface of the core is sprayed with the solution for coating layer formation, a fluidized bed method in which the core is suspended in an air stream and are sprayed with the solution for coating layer formation, and a kneader-coater method in which the carrier core and the solution for coating layer formation are mixed in a kneader-coater and the solvent is removed.

The mixing ratio (mass ratio) of the toner to the carrier in the two-component developer is preferably 1:100 to 30:100, more preferably 3:100 to 20:100.

### Image Forming Apparatus

The image forming apparatus according to the exemplary embodiment will be described in detail.

The image forming apparatus according to the exemplary embodiment includes an image carrier; a charging unit that charges a surface of the image carrier; an electrostatic image forming unit that forms an electrostatic image on the charged surface of the image carrier; a developing unit that contains an electrostatic image developer containing an electrostatic image developing toner and a carrier, that includes a supply member that is configured to rotate while holding the electrostatic image developer on a circumferential surface thereof to thereby supply the electrostatic image developing toner to the electrostatic image and that has in the circumferential surface a plurality of grooves extending in a direction intersecting the direction of rotation, and that develops the electrostatic image formed on the surface of the image carrier with the electrostatic image developer to form a toner image; a transfer unit that transfers the toner image formed on the surface of the image carrier to a surface of a recording medium; and a fixing unit that fixes the toner image transferred to the surface of the recording medium.

The specific toner described above is used as the electrostatic image developing toner.

The image forming apparatus according to the exemplary embodiment executes an image forming method including a charging step of charging a surface of an image carrier, an electrostatic image forming step of forming an electrostatic image on the charged surface of the image carrier, a developing step of developing the electrostatic image formed on the surface of the image carrier with an electrostatic image developer containing the specific toner and a carrier to form a toner image, a transferring step of transferring the toner image formed on the surface of the image carrier to a surface of a recording medium, and a fixing step of fixing the toner image transferred to the surface of the recording medium.

The image forming apparatus according to the exemplary embodiment may be a known type of image forming apparatus: for example, a direct-transfer apparatus that transfers a toner image formed on a surface of an image carrier directly to a recording medium; an intermediate-transfer apparatus that first transfers a toner image formed on a surface of an image carrier to a surface of an intermediate transfer body and then transfers the toner image transferred to the surface of the intermediate transfer body to a surface of a recording medium; an apparatus including a cleaning unit that cleans a surface of an image carrier after the transfer of a toner image and before charging; or an apparatus including an erasing unit that erases charge on a surface of an image carrier by irradiation with erasing light after the transfer of a toner image and before charging.

When the image forming apparatus according to the exemplary embodiment is an intermediate-transfer apparatus, the transfer unit includes, for example, an intermediate transfer body having a surface to which a toner image is transferred, a first transfer unit that transfers a toner image formed on a surface of an image carrier to the surface of the intermediate transfer body, and a second transfer unit that transfers the toner image transferred to the surface of the intermediate transfer body to a surface of a recording medium.

In the image forming apparatus according to the exemplary embodiment, the section including the developing unit may be, for example, a cartridge structure (process cartridge) attachable to and detachable from the image forming apparatus. For example, a process cartridge including a developing unit containing the electrostatic image developer according to the exemplary embodiment is suitable for use as the process cartridge.

A non-limiting example of the image forming apparatus according to the exemplary embodiment will now be described. In the following description, parts illustrated in the drawings are described, and other parts are not described.

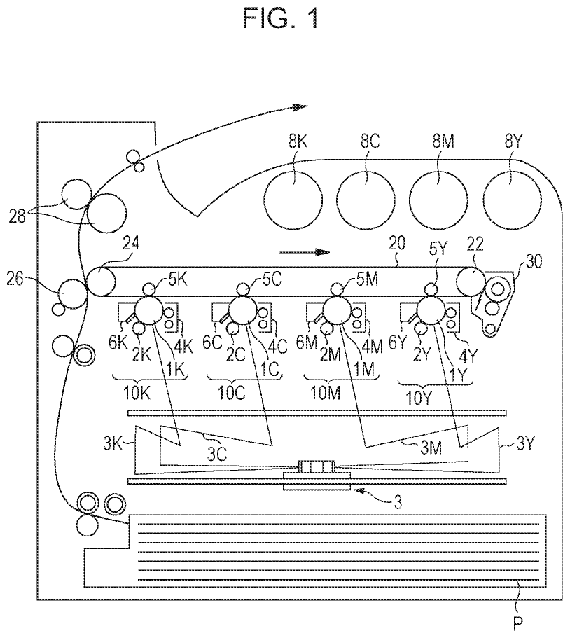

FIG. 1 is a schematic diagram illustrating the image forming apparatus according to the exemplary embodiment.

The image forming apparatus illustrated in FIG. 1 includes first to fourth electrophotographic image forming units 10Y, 10M, 10C, and 10K which respectively output yellow (Y), magenta (M), cyan (C), and black (K) images based on color-separated image data. These image forming units (hereinafter also referred to simply as “units”) 10Y, 10M, 10C, and 10K are arranged side by side at predetermined intervals in the horizontal direction. The units 10Y, 10M, 10C, and 10K may be process cartridges attachable to and detachable from the image forming apparatus.

An intermediate transfer belt 20 (an example of the intermediate transfer body) extends above the units 10Y, 10M, 10C, and 10K so as to pass through the units. The intermediate transfer belt 20 is wound around a drive roller 22 and a support roller 24, which are in contact with the inner surface of the intermediate transfer belt 20, and is configured to run in the direction from the first unit 10Y toward the fourth unit 10K. A spring or the like (not shown) applies a force to the support roller 24 in the direction away from the drive roller 22, so that tension is applied to the intermediate transfer belt 20 wound around the rollers 22 and 24. An intermediate transfer belt cleaning device 30 is provided on the image carrier side of the intermediate transfer belt 20 so as to face the drive roller 22.

The units 10Y, 10M, 10C, and 10K respectively include developing devices (examples of developing units) 4Y, 4M, 4C, and 4K to which yellow, magenta, cyan, and black toners are respectively supplied from toner cartridges 8Y, 8M, 8C, and 8K.

The first to fourth units 10Y, 10M, 10C, and 10K have the same structure and function. Thus, the first unit 10Y, which is disposed upstream in the running direction of the intermediate transfer belt and forms a yellow image, will be described as a representative.

The first unit 10Y includes a photoreceptor 1Y. The photoreceptor 1Y functions as an image carrier and is surrounded by, in sequence, a charging roller 2Y (an example of the charging unit), an exposure device 3 (an example of the electrostatic image forming unit), a developing device 4Y (an example of the developing unit), a first transfer roller 5Y (an example of the first transfer unit), and a photoreceptor cleaning device 6Y (an example of the image carrier cleaning unit). The charging roller 2Y charges the surface of the photoreceptor 1Y to a predetermined potential. The exposure device 3 exposes the charged surface to a laser beam 3Y based on a color-separated image signal to form an electrostatic image. The developing device 4Y supplies a charged toner to the electrostatic image to develop the electrostatic image. The first transfer roller 5Y transfers the developed toner image to the intermediate transfer belt 20. The photoreceptor cleaning device 6Y removes the toner remaining on the surface of the photoreceptor 1Y after the first transfer.

The first transfer roller 5Y is disposed inside the intermediate transfer belt 20 so as to face the photoreceptor 1Y. The first transfer rollers 5Y, 5M, 5C, and 5K of the units are each connected to a bias power supply (not shown) that applies a first transfer bias. The value of transfer bias applied from each bias power supply to each first transfer roller is changed by control of a controller (not shown).

The operation of the first unit 10Y to form a yellow image will now be described.

Prior to the operation, the charging roller 2Y charges the surface of the photoreceptor 1Y to a potential of −600 V to −800 V.

The photoreceptor 1Y is formed of a conductive substrate (having a volume resistivity at 20° C. of, for example, 1×10⁻⁶ Ωcm or less) and a photosensitive layer disposed on the substrate. The photosensitive layer, which normally has high resistivity (resistivity of common resins), has the property of changing its resistivity in a region irradiated with a laser beam. The exposure device 3 applies the laser beam 3Y to the charged surface of the photoreceptor 1Y on the basis of yellow image data sent from the controller (not shown). As a result, an electrostatic image with a yellow image pattern is formed on the surface of the photoreceptor 1Y.

The electrostatic image is an image formed on the surface of the photoreceptor 1Y by charging. Specifically, the electrostatic image is what is called a negative latent image formed in the following manner: in the portion of the photosensitive layer irradiated with the laser beam 3Y, the resistivity drops, and the charge on the surface of the photoreceptor 1Y dissipates from the region, while the charge remains in the portion not irradiated with the laser beam 3Y.

As the photoreceptor 1Y rotates, the electrostatic image formed on the photoreceptor 1Y is brought to a predetermined development position. At the development position, the electrostatic image on the photoreceptor 1Y is developed by the developing device 4Y to form a visible toner image.

The developing device 4Y contains, for example, an electrostatic image developer containing at least a yellow toner and a carrier. The yellow toner is frictionally charged as it is stirred inside the developing device 4Y, and thus has a charge with the same polarity (negative) as that of the charge on the photoreceptor 1Y and is held on a developer roller (an example of the developer holding body). As the surface of the photoreceptor 1Y passes through the developing device 4Y, the yellow toner is electrostatically attached to the neutralized latent image portion on the surface of the photoreceptor 1Y to develop the latent image. The photoreceptor 1Y on which the yellow toner image is formed rotates at a predetermined speed to transport the toner image developed on the photoreceptor 1Y to a predetermined first transfer position.

When the yellow toner image on the photoreceptor 1Y is transported to the first transfer position, a first transfer bias is applied to the first transfer roller 5Y, and electrostatic force directed from the photoreceptor 1Y toward the first transfer roller 5Y acts on the toner image to transfer the toner image on the photoreceptor 1Y to the intermediate transfer belt 20. The transfer bias applied has the opposite polarity (positive) to the toner (negative). In the first unit 10Y, the transfer bias is controlled to, for example, +10 μA by the controller (not shown). The toner remaining on the photoreceptor 1Y is removed and collected by the photoreceptor cleaning device 6Y.

The first transfer biases applied to the first transfer rollers 5M, 5C, and 5K of the second to fourth units 10M, 10C, and 10K are controlled in the same manner as in the first unit.

Thus, the intermediate transfer belt 20 to which the yellow toner image is transferred by the first unit 10Y is sequentially transported through the second to fourth units 10M, 10C, and 10K, and as a result, toner images of the respective colors are transferred in a superimposed manner.

The intermediate transfer belt 20, to which the toner images of the four colors are transferred in a superimposed manner through the first to fourth units, runs to a second transfer section including the intermediate transfer belt 20, the support roller 24 in contact with the inner surface of the intermediate transfer belt, and a second transfer roller 26 (an example of the second transfer unit) disposed on the image carrier side of the intermediate transfer belt 20. A sheet of recording paper P (an example of the recording medium) is fed into the nip between the second transfer roller 26 and the intermediate transfer belt 20 at a predetermined timing by a feed mechanism, and a second transfer bias is applied to the support roller 24. The transfer bias applied has the same polarity (negative) as the toner (negative), and electrostatic force directed from the intermediate transfer belt 20 toward the sheet of recording paper P acts on the toner image to transfer the toner image on the intermediate transfer belt 20 to the sheet of recording paper P. The second transfer bias is determined depending on the resistance detected by a resistance detector (not shown) that detects the resistance of the second transfer section, and thus the voltage is controlled.

The sheet of recording paper P to which the toner image is transferred is sent to a pressure-contact part (nip part) between a pair of fixing rollers of a fixing device 28 (an example of the fixing unit), and the toner image is fixed to the sheet of recording paper P, thus forming a fixed image. The sheet of recording paper P after completion of the fixing of the color image is conveyed to a discharge unit. Thus, the color image forming operation is complete.

Examples of recording paper P to which toner images are transferred include plain paper for use in electrophotographic copiers, printers, and other devices. Examples of recording media other than the recording paper P include OHP sheets. To further improve the surface smoothness of the fixed image, the surface of the recording paper P may also be smooth. For example, coated paper, i.e., plain paper coated with resin or the like and art paper for printing are suitable for use.

### Process Cartridge

The process cartridge according to the exemplary embodiment is attachable to and detachable from an image forming apparatus and includes a developing unit that contains an electrostatic image developer containing an electrostatic image developing toner and a carrier, that includes a supply member that is configured to rotate while holding the electrostatic image developer on a circumferential surface thereof to thereby supply the electrostatic image developing toner to an electrostatic image formed on an image carrier and that has in the circumferential surface a plurality of grooves extending in a direction intersecting the direction of rotation, and that develops the electrostatic image formed on the surface of the image carrier with the electrostatic image developer to form a toner image. The electrostatic image developing toner satisfies (ln η(T1)−ln η(T2))/(T1−T2)≤−0.14, (ln η(T2)−ln η(T3))/(T2−T3)≥−0.15, and (ln η(T2)−ln η(T3))/(T2−T3)>(ln η(T1)−ln η(T2))/(T1−T2), wherein η(T1) is a viscosity η of the toner at temperature T1=60° C., η(T2) is a viscosity η of the toner at temperature T2=90° C., and η(T3) is a viscosity η of the toner at temperature T3=130° C.

The process cartridge according to the exemplary embodiment may include the developing unit and optionally at least one other unit selected from an image carrier, a charging unit, an electrostatic image forming unit, and a transfer unit.

A non-limiting example of the process cartridge according to the exemplary embodiment will now be described. In the following description, parts illustrated in the drawings are described, and other parts are not described.

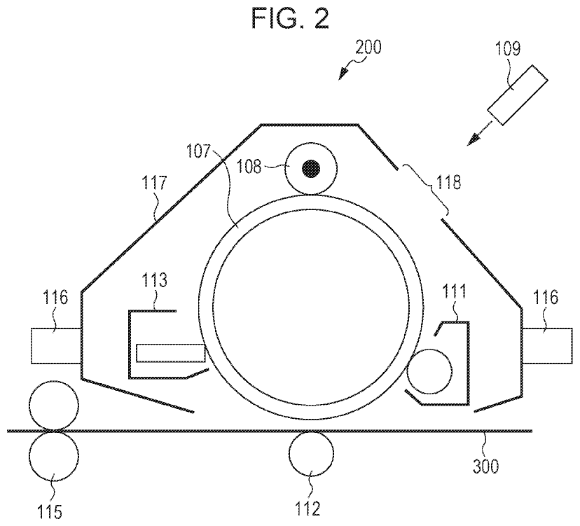

FIG. 2 is a schematic diagram illustrating an example of the process cartridge according to the exemplary embodiment.

A process cartridge 200 illustrated in FIG. 2 includes, for example, a photoreceptor 107 (an example of the image carrier), a charging roller 108 (an example of the charging unit) disposed on the periphery of the photoreceptor 107, a developing device 111 (an example of the developing unit), and a photoreceptor cleaning device 113 (an example of the cleaning unit) which are assembled into a cartridge with a housing 117 having mounting rails 116 and an opening 118 for exposure.

In FIG. 2, 109 represents an exposure device (an example of the electrostatic image forming unit), 112 represents a transfer device (an example of the transfer unit), 115 represents a fixing device (an example of the fixing unit), and 300 represents a sheet of recording paper (an example of the recording medium).

### Toner Cartridge

Next, the toner cartridge used in the exemplary embodiment will be described.

The toner cartridge used in the exemplary embodiment contains the specific toner used in the exemplary embodiment and is attachable to and detachable from an image forming apparatus. The toner cartridge contains refill toner to be supplied to a developing unit provided in the image forming apparatus.

The image forming apparatus illustrated in FIG. 1 is configured such that the toner cartridges 8Y, 8M, 8C, and 8K are attachable thereto and detachable therefrom. The developing devices 4Y, 4M, 4C, and 4K are connected to the toner cartridges corresponding to the colors of the developing devices through toner supply tubes (not shown). The toner cartridges are replaced when the amount of toner therein is decreased.

### Configuration of Principal Component

Next, the developing unit used in the exemplary embodiment will be described in detail.

The developing unit used in the exemplary embodiment contains an electrostatic image developer containing the specific toner and a carrier and includes a supply member that is configured to rotate while holding the electrostatic image developer on a circumferential surface thereof to thereby supply the electrostatic image developing toner to the electrostatic image and that has in the circumferential surface a plurality of grooves extending in a direction intersecting the direction of rotation.

The developing unit may also include a regulating member that regulates the amount of developer on the supply member.

The phrase “grooves extending in a direction intersecting the direction of rotation” should be construed to include grooves extending in a direction intersecting the direction of rotation at right angles (90°) and, in addition, in directions displaced by ±30° from the direction intersecting the direction of rotation at right angles. In other words, the grooves in the circumferential surface of the supply member include not only grooves extending in a direction parallel to the axis of the supply member but also grooves extending in directions inclined at ±30° to the axis.

The exemplary embodiment will now be described in detail with reference to the drawings.

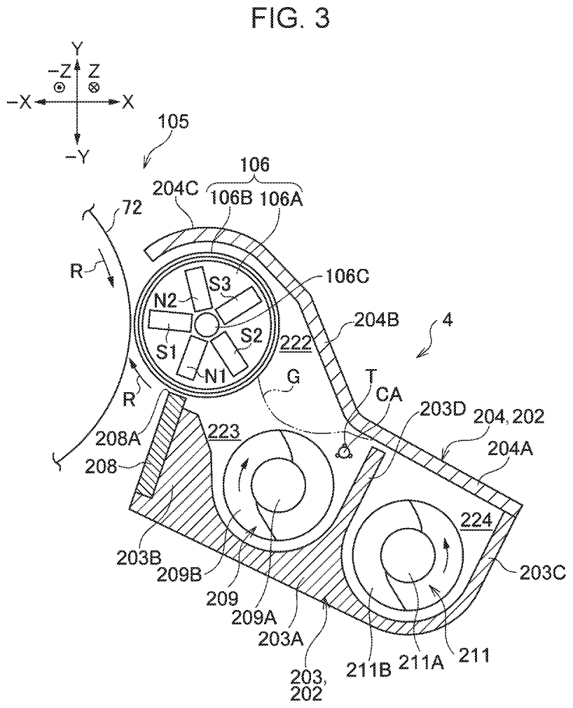

FIG. 3 is a sectional view of the developing unit according to the exemplary embodiment.

As illustrated in FIG. 3, a developing device 4 (an example of the “developing unit”) includes a housing 202, a developing roller 106 (an example of the “supply member”), a regulating member 208, a first auger 209, and a second auger 211. The housing 202 contains a developer G (an example of the “electrostatic image developer”). The regulating member 208 regulates the thickness of a layer of the developer G held on an outer circumferential surface of the developing roller 106. The first auger 209 supplies the developer G to the developing roller 106. The second auger 211 transports the developer G in a circulating manner together with the first auger 209.

For example, the developer G is a two-component developer containing a toner T (an example of the “specific toner”) in the form of negatively charged particles and a magnetic carrier CA (an example of the “carrier”) in the form of positively charged magnetic particles. The magnetic carrier CA is a small-size carrier with a particle size of 30 μm or less (e.g., 25 μm), and the toner T is a small-size toner with a particle size of 4 μm or less (e.g., 3.8 μm).

The housing 202 includes a container body 203 and a covering member 204 covering the top of the container body 203. The housing 202 has a developing roller chamber 222, a first stirring chamber 223, and a second stirring chamber 224. The developing roller chamber 222 contains the developing roller 106. The first stirring chamber 223 is provided below the developing roller chamber 222. The second stirring chamber 224 is adjacent to the first stirring chamber 223.

The container body 203, as viewed in the Z direction, includes a bottom wall 203A, an attachment portion 203B, a side wall 203C, and a partition wall 203D. The bottom wall 203A is curved at two positions so as to protrude in the −Y direction. The attachment portion 203B is disposed at the end of the bottom wall 203A in the −X direction. The side wall 203C is disposed upright at the end of the bottom wall 203A in the X direction. The partition wall 203D is disposed upright at the center of the bottom wall 203A and separates the first stirring chamber 223 from the second stirring chamber 224.

The covering member 204 includes a top wall 204A, an inclined wall 204B, and a curved wall 204C. The top wall 204A is disposed above the second stirring chamber 224. The inclined wall 204B extends diagonally from the end of the top wall 204A in the −X direction to the upper left so as to cover the developing roller chamber 222. The curved wall 204C continues from the upper end of the inclined wall 204B.

The developing roller 106 includes a magnetic roller 106A, an example of a magnetic source, and a developing sleeve 106B, an example of a developer holding member. The magnetic roller 106A has a cylindrical shape and is immovably supported by the container body 203 through a shaft 106C. The developing sleeve 106B has a cylindrical shape and is rotatably supported outside the magnetic roller 106A. That is, the magnetic roller 106A is disposed inside the developing sleeve 106B.

The magnetic roller 106A includes a plurality of magnetic poles disposed along the outer circumferential surface thereof (in the circumferential direction) and generates a magnetic force to attract the developer G. Specifically, as viewed in the axial direction of the shaft 106C, the magnetic roller 106A includes, in order from the lower right near the first auger 209 in the rotational direction (R direction), a pick-up pole S2, a layer-forming pole N1, a developing pole S1, a transport pole N2, and a pick-off pole S3. The pick-up pole S2 attracts the developer G. The layer-forming pole N1 is disposed so as to face the regulating member 208. The developing pole S1 is disposed so as to face a photoreceptor 72. The transport pole N2 causes the residual developer G after development to be held on the outer circumferential surface of the developing sleeve 106B. The pick-off pole S3 removes the developer G from the outer circumferential surface of the developing sleeve 106B.

In the following, the positions of the magnetic poles are described by referring to the top and bottom positions of the magnetic roller 106A as viewed in the axial direction (Z direction) as “12 o'clock position” and “6 o'clock position,” respectively. For example, the pick-up pole S2 is disposed at the 4 o'clock position to cause the developer G to be attracted to and held on the outer circumferential surface of the developing sleeve 106B. The layer-forming pole N1 is disposed at the 7 o'clock position, which is opposite the tip of the regulating member 208, and causes a plurality of magnetic carriers CA in the form of a brush to be held on the outer circumferential surface of the developing sleeve 106B.

The developing pole S1 is disposed at the 9 o'clock position, which is opposite the outer circumferential surface of the photoreceptor 72. The transport pole N2 is disposed at the 11 o'clock position. After the development on the photoreceptor 72 is complete, the transport pole N2 causes the residual developer G to be attracted to and held on the outer circumferential surface of the developing sleeve 106B. The pick-off pole S3 is disposed at the 2 o'clock position to remove the developer G from the developing sleeve 106B at between the pick-up pole S2 and the pick-off pole S3.

For example, the developing sleeve 106B is a tubular aluminum member. Cap-shaped support members (not illustrated) are attached to and cover opposite ends of the developing sleeve 106B in the Z direction, and bearings (not illustrated) are fixed inside the support members. The shaft 106C is inserted through the bearings so that the developing sleeve 106B is rotatable about the magnetic roller 106A in the circumferential direction. The developing sleeve 106B is configured to be driven in rotation in the +R direction by a drive unit (not illustrated) including a motor and a gear.

Next, regarding the plurality of grooves formed in the circumferential surface of the developing roller 106 and extending in a direction intersecting the direction of rotation of the developing roller, the exemplary embodiment will be described in detail with reference to the drawing.

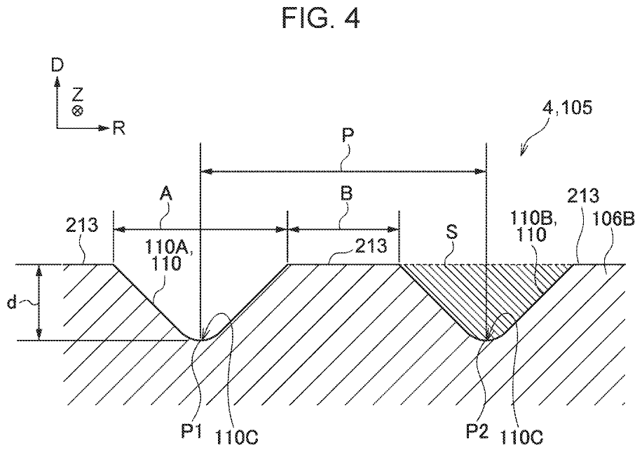

FIG. 4 is a sectional view of grooves formed in a surface of the supply member used in the exemplary embodiment and the vicinity of the grooves.

As illustrated in FIG. 4, a plurality of grooves 110 (an example of the “grooves”), which will be described below in detail, are formed in the outer circumferential surface of the developing sleeve 106B. The grooves formed in the outer circumferential surface of the developing sleeve 106B may have any shape, but to better hold a developer, their section as viewed in the axial direction of the developing sleeve 106B is preferably V-shaped or U-shaped, more preferably V-shaped. The axial direction and the rotational direction (R direction) of the developing sleeve 106B are the same as those of the photoreceptor 72, and the developing sleeve 106B is disposed so as to face the outer circumferential surface of the photoreceptor 72. The developing sleeve 106B rotates in a direction counter to the rotational direction of the photoreceptor 72 while holding the developer G on the outer circumferential surface thereof, and at a position (development area) where the developing sleeve 106B faces the photoreceptor 72, the electrostatic image (latent image) on the photoreceptor 72 is developed with the toner T.

In the first stirring chamber 223, the first auger 209, which transports the developer G while stirring it, is disposed. The first auger 209 includes a rotating shaft 209A disposed along the Z direction and a helical blade 209B supported on the outer periphery of the rotating shaft 209A. The first auger 209 is disposed so as to face the developing sleeve 106B upstream of the regulating member 208 in the rotational direction of the developing sleeve 106B. The rotation axis direction (Z direction) of the first auger 209 is the same as that of the developing sleeve 106B. The blade 209B is configured to rotate to transport the developer G in the rotation axis direction and supply the developer G to the developing sleeve 106B.

In the second stirring chamber 224, the second auger 211, which transports the developer G while stirring it, is disposed. The second auger 211 includes a rotating shaft 211A disposed along the Z direction and a blade 211B supported on the outer periphery of the rotating shaft 211A. The second auger 211 is configured to rotate counter to the first auger 209 to transport the developer G in a circulating manner together with the first auger 209.

The developer G in the first stirring chamber 223 is held on the developing sleeve 106B under the action of the pick-up pole S2 and transported as the developing sleeve 106B rotates in the R direction. The developer G held on the developing sleeve 106B is then advanced to the nip between the outer circumferential surface of the developing sleeve 106B and the tip of the regulating member 208, and as a result the thickness of the layer of the developer G is regulated. The developer G is then transported to the development area facing the photoreceptor 72.

The regulating member 208 is a plate-shaped member elongated in the Z direction. The regulating member 208 is disposed so as to face the outer circumferential surface of the developing sleeve 106B, with the transverse direction thereof oriented in a direction slightly inclined from the Y direction toward the X direction and the tip (upper end surface 208A) thereof facing the shaft 106C. That is, the regulating member 208 is disposed below the developing sleeve 106B in the Y direction and disposed so as to face the layer-forming pole N1 with the developing sleeve 106B therebetween. The regulating member 208 is configured to regulate the thickness of the developer layer held on the outer circumferential surface of the developing sleeve 106B.

Next, the grooves 110 will be described in detail.

As illustrated in the enlarged view of FIG. 4, the plurality of grooves 110 are formed in the outer circumferential surface of the developing sleeve 106B along its circumference at intervals (B described below) within a predetermined acceptable range. In FIG. 4, the circumferential direction of the developing sleeve 106B is indicated by the direction of arrow R, which is the rotational direction, and the radial direction of the developing sleeve 106B is indicated by the direction of arrow D. The grooves 110 have the same configuration in the circumferential direction (R direction) of the developing sleeve 106B. Thus, FIG. 4 illustrates two adjacent grooves 110A and 110B alone, and the illustration and description of other grooves 110 are omitted. When one of the grooves 110 is described, it is expressed as the groove 110, and the letters A and B are omitted.

The groove 110 has a V-shaped section as viewed in the axial direction (Z direction) of the developing sleeve 106B. The groove 110 extends in the Z direction and has one single sectional shape in the Z direction. The groove 110 is symmetric in the R direction about a deepest part 110C at the center in the R direction. The term “V-shaped” may be used not only when the deepest part 110C is formed as oblique surfaces at an acute angle but also when the deepest part 110C is formed as a curved surface.

In FIG. 4, the groove pitch of the grooves 110 is indicated by P, the opening width in the R direction (circumferential direction) by A, the interval between the adjacent grooves 110A and 110B in the circumferential direction by B, and the depth of the grooves 110 by d. The sectional area (expressed in mm²) representing the inner volume of the groove 110 is indicated by S. The groove pitch P is a distance from a center position P1 in the R direction of the groove 110A to a center position P2 in the R direction of the groove 110B. An interval B corresponds to the width in the R direction of a portion (non-groove portion 213) other than the grooves 110 of the developing sleeve 106B. In addition, the sectional area S representing the inner volume is approximately calculated by S=A×d/2 because the curved portion of the deepest part 110C is much smaller than the other portions and can be considered to be an acute angle.

In the exemplary embodiments, the average pitch of the supply member in the circumferential direction means the average of pitches (P in FIG. 4) of all the grooves (grooves 110) provided along the circumference of the developing sleeve 106B as viewed in the axial direction.

Likewise, the average width of the grooves in the supply member means the average of opening widths (A in FIG. 4) of all the grooves (grooves 110) provided along the circumference of the developing sleeve 106B as viewed in the axial direction.

Likewise, the depth (L4) of the grooves in the supply member means the average of depths of all the grooves provided along the circumference of the developing sleeve 106B as viewed in the axial direction.

To stabilize the amount of toner transported by the supply member and reduce the occurrence of color spots in images, the average pitch of the grooves along the circumference of the developing sleeve 106B is preferably 0.6 mm or less, more preferably 0.4 mm or less. The lower limit of the groove pitch is preferably, but not necessarily, 0.2 mm or more.

To stabilize the amount of toner transported by the supply member and reduce the occurrence of color spots in images, the ratio (L2/L1) of the average pitch (L2) of the grooves 110 to the average particle size (L1) of the magnetic carriers CA is preferably 5.7 or more and 17.1 or less, more preferably 5.7 or more and 11.4 or less.

The average particle size of the magnetic carriers CA is measured by a method described in EXAMPLES below.

To stabilize the amount of toner transported by the supply member and reduce the occurrence of color spots in images, the average width (L3) of the grooves is preferably 0.1 mm or more and 0.3 mm or less, more preferably 0.15 mm or more and 0.25 mm or less.

To stabilize the amount of toner transported by the supply member and reduce the occurrence of color spots in images, the ratio (L3/L1) of the average width (L3) of the grooves 110 to the average particle size (L1) of the magnetic carriers CA is preferably 2.8 or more and 8.6 or less, more preferably 4.3 or more and 7.1 or less.

To stabilize the amount of toner transported by the supply member and reduce the occurrence of color spots in images, the average depth (L4) of the grooves is preferably 0.05 mm or more and 0.3 mm or less, more preferably 0.05 mm or more and 0.2 mm or less.

The ratio (L5/L4) of the shortest distance (L5) between the regulating member 208 and the surface of the supply member (i.e., the surface of the developing sleeve 106B) to the depth (L4) of the grooves 110 is preferably 1.4 or more.

When the ratio (L5/L4) is 1.4 or more, cracking and chipping of toner may be reduced, which may result in images with stable image quality. The upper limit of the ratio (L5/L4) is preferably, but not necessarily, 8.5 or less.

### EXAMPLES

Examples of the present disclosure will now be described, but the present disclosure is not limited to the following examples. In the following description, all parts and percentages are by mass unless otherwise specified.

The viscosity, maximum endothermic peak temperature, and absorbance at predetermined wave numbers of toners are measured by the methods described above.

### Developers A1 to A14 and B1 to B3

Preparation of styrene-acrylic resin particle dispersion
Preparation of resin particle dispersion (1)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1 part

A solution of 4 parts of an anionic surfactant (DOWFAX manufactured by Dow Chemical Company) in 550 parts of ion-exchanged water is put in a flask, and a mixed solution of the above raw materials is added thereto to form an emulsion. A solution of 6 parts of ammonium persulfate in 50 parts of ion-exchanged water is added to the emulsion over 10 minutes with slow stirring. The system is then thoroughly purged with nitrogen and heated to 75° C. in an oil bath to effect polymerization for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 2 parts

Next, a mixed solution of these raw materials is emulsified. The emulsion is added to the flask over 120 minutes, and emulsion polymerization is continued for 4 hours. This yields a resin particle dispersion in which resin particles having a weight average molecular weight of 32,000, a glass transition temperature of 53° C., and a volume average particle size of 240 nm are dispersed. Ion-exchanged water is added to the resin particle dispersion to a solids content of 20 mass % to provide a resin particle dispersion (1).

Preparation of resin particle dispersion (2)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1.5 parts

A solution of 4 parts of an anionic surfactant (DOWFAX manufactured by Dow Chemical Company) in 550 parts of ion-exchanged water is put in a flask, and a mixed solution of the above raw materials is added thereto to form an emulsion. A solution of 6 parts of ammonium persulfate in 50 parts of ion-exchanged water is added to the emulsion over 10 minutes with slow stirring. The system is then thoroughly purged with nitrogen and heated to 75° C. in an oil bath to effect polymerization for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 2.5 parts

Next, a mixed solution of these raw materials is emulsified. The emulsion is added to the flask over 120 minutes, and emulsion polymerization is continued for 4 hours. This yields a resin particle dispersion in which resin particles having a weight-average molecular weight of 30,000, a glass transition temperature of 53° C., and a volume-average particle size of 220 nm are dispersed. Ion-exchanged water is added to the resin particle dispersion to a solids content of 20 mass % to provide a resin particle dispersion (2).

### Preparation of Resin Particle Dispersion (3)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 1.5 parts

A solution of 4 parts of an anionic surfactant (DOWFAX manufactured by Dow Chemical Company) in 550 parts of ion-exchanged water is put in a flask, and a mixed solution of the above raw materials is added thereto to form an emulsion. A solution of 7 parts of ammonium persulfate in 50 parts of ion-exchanged water is added to the emulsion over 10 minutes with slow stirring. The system is then thoroughly purged with nitrogen and heated to 80° C. in an oil bath to effect polymerization for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 3.0 parts

Next, a mixed solution of these raw materials is emulsified. The emulsion is added to the flask over 120 minutes, and emulsion polymerization is continued for 4 hours. This yields a resin particle dispersion in which resin particles having a weight average molecular weight of 28,000, a glass transition temperature of 53° C., and a volume-average particle size of 230 nm are dispersed. Ion-exchanged water is added to the resin particle dispersion to a solids content of 20 mass % to provide a resin particle dispersion (3).

### Preparation of Resin Particle Dispersion (4)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 2.0 parts

A solution of 4 parts of an anionic surfactant (DOWFAX manufactured by Dow Chemical Company) in 550 parts of ion-exchanged water is put in a flask, and a mixed solution of the above raw materials is added thereto to form an emulsion. A solution of 7.5 parts of ammonium persulfate in 50 parts of ion-exchanged water is added to the emulsion over 10 minutes with slow stirring. The system is then thoroughly purged with nitrogen and heated to 85° C. in an oil bath to effect polymerization for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 3.5 parts

Next, a mixed solution of these raw materials is emulsified. The emulsion is added to the flask over 120 minutes, and emulsion polymerization is continued for 4 hours. This yields a resin particle dispersion in which resin particles having a weight average molecular weight of 26,500, a glass transition temperature of 53° C., and a volume average particle size of 210 nm are dispersed. Ion-exchanged water is added to the resin particle dispersion to a solids content of 20 mass % to provide a resin particle dispersion (4).

### Preparation of Resin Particle Dispersion (5)

Styrene: 200 parts

n-Butyl acrylate: 50 parts

Acrylic acid: 1 part

β-Carboxyethyl acrylate: 3 parts

Propanediol diacrylate: 1 part

2-Hydroxyethyl acrylate: 0.5 parts

Dodecanethiol: 0.8 parts

A solution of 4 parts of an anionic surfactant (DOWFAX manufactured by Dow Chemical Company) in 550 parts of ion-exchanged water is put in a flask, and a mixed solution of the above raw materials is added thereto to form an emulsion. A solution of 5.5 parts of ammonium persulfate in 50 parts of ion-exchanged water is added to the emulsion over 10 minutes with slow stirring. The system is then thoroughly purged with nitrogen and heated to 85° C. in an oil bath to effect polymerization for 30 minutes.

Styrene: 110 parts

n-Butyl acrylate: 50 parts

β-Carboxyethyl acrylate: 5 parts

1,10-Decanediol diacrylate: 2.5 parts

Dodecanethiol: 1.7 parts

Next, a mixed solution of these raw materials is emulsified. The emulsion is added to the flask over 120 minutes, and emulsion polymerization is continued for 4 hours. This yields a resin particle dispersion in which resin particles having a weight average molecular weight of 36,000, a glass transition temperature of 53° C., and a volume average particle size of 260 nm are dispersed. Ion-exchanged water is added to the resin particle dispersion to a solids content of 20 mass % to provide a resin particle dispersion (5).

### Preparation of Magenta-Colored Particle Dispersion

C.I. Pigment Red 122: 50 parts
Anionic surfactant (NEOGEN RK manufactured by Dai-Ichi Kogyo Seiyaku Co., Ltd.): 5 parts
Ion-exchanged water: 220 parts

These materials are mixed together and processed with an ULTIMIZER (manufactured by Sugino Machine Limited) at 240 MPa for 10 minutes to prepare a magenta-colored particle dispersion (solids content: 20%).

### Preparation of Release Agent Particle Dispersion (1)

Ester wax (WEP-2 manufactured by NOF Corporation): 100 parts
Anionic surfactant (NEOGEN RK manufactured by Dai-Ichi Kogyo Seiyaku Co., Ltd.): 2.5 parts
Ion-exchanged water: 250 parts

These materials are mixed together and heated to 120° C. The mixture is dispersed using a homogenizer (ULTRA-TURRAX T50 manufactured by IKA), and a dispersion treatment is then performed with a MANTON-GAULIN high-pressure homogenizer (manufactured by Gaulin Corporation) to provide a release agent particle dispersion (1) (solids content: 29.1%) in which release agent particles having a volume average particle size of 330 nm are dispersed.

### Preparation of Release Agent Particle Dispersion (2)

Fischer-Tropsch wax (HNP-9 manufactured by Nippon Seiro Co., Ltd.): 100 parts
Anionic surfactant (NEOGEN RK manufactured by Dai-Ichi Kogyo Seiyaku Co., Ltd.): 2.5 parts
Ion-exchanged water: 250 parts

These materials are mixed together and heated to 120° C. The mixture is dispersed using a homogenizer (ULTRA-TURRAX T50 manufactured by IKA), and a dispersion treatment is then performed with a MANTON-GAULIN high-pressure homogenizer (manufactured by Gaulin Corporation) to provide a release agent particle dispersion (2) (solids content: 29.2%) in which release agent particles having a volume average particle size of 340 nm are dispersed.

### Preparation of Release Agent Particle Dispersion (3)

Paraffin wax (FNP0090 manufactured by Nippon Seiro Co., Ltd.): 100 parts
Anionic surfactant (NEOGEN RK manufactured by Dai-Ichi Kogyo Seiyaku Co., Ltd.): 2.5 parts
Ion-exchanged water: 250 parts

These materials are mixed together and heated to 120° C. The mixture is dispersed using a homogenizer (ULTRA-TURRAX T50 manufactured by IKA), and a dispersion treatment is then performed with a MANTON-GAULIN high-pressure homogenizer (manufactured by Gaulin Corporation) to provide a release agent particle dispersion (3) (solids content: 29.0%) in which release agent particles having a volume average particle size of 360 nm are dispersed.

### Preparation of Release Agent Particle Dispersion (4)

Polyethylene wax (POLYWAX 725 manufactured by Toyo Adl Corporation): 100 parts
Anionic surfactant (NEOGEN RK manufactured by Dai-Ichi Kogyo Seiyaku Co., Ltd.): 2.5 parts
Ion-exchanged water: 250 parts

These materials are mixed together and heated to 100° C. The mixture is dispersed using a homogenizer (ULTRA-TURRAX T50 manufactured by IKA), and a dispersion treatment is then performed with a MANTON-GAULIN high-pressure homogenizer (manufactured by Gaulin Corporation) to provide a release agent particle dispersion (4) (solids content: 29.3%) in which release agent particles having a volume average particle size of 370 nm are dispersed.

### Process for Producing Toner A1

Ion-exchanged water: 400 parts

Resin particle dispersion (1): 200 parts

Magenta-colored particle dispersion: 40 parts

Release agent particle dispersion (2): 12 parts

Release agent particle dispersion (3): 24 parts

These components are put in a reaction vessel equipped with a thermometer, a pH meter, and a stirrer, and maintained at a temperature of 30° C. and a stirring speed of 150 rpm for 30 minutes while controlling the temperature with an external mantle heater.

The mixture is dispersed with a homogenizer (ULTRA-TURRAX T50 manufactured by IKA Japan) while adding an aqueous PAC solution of 2.1 parts of polyaluminum chloride (PAC, manufactured by Oji Paper Co., Ltd: 30% powder product) in 100 parts of ion-exchanged water. The temperature is then raised to 50° C., and the particle size is measured with a COULTER MULTISIZER II (aperture size: 50 μm, manufactured by Beckman Coulter, Inc.) to determine the volume-average particle size to be 5.0 μm. Thereafter, 115 parts of the resin particle dispersion (1) is additionally added to make the resin particles adhere to the surface of the aggregate particles (to form a shell structure).

Subsequently, 20 parts of a 10 mass % aqueous NTA (nitrilotriacetic acid) metal salt solution (CHELEST 70: manufactured by Chelest Corporation) is added, and the pH is then adjusted to 9.0 with a 1 N aqueous sodium hydroxide solution. The mixture is then heated to 91° C. at a heating rate of 0.05° C./min and maintained at 91° C. for 3 hours. The resulting toner slurry is then cooled to 85° C. and maintained there for 1 hour. Thereafter, the toner slurry is cooled to 25° C. to obtain a magenta toner. The magenta toner is further washed by repeatedly performing redispersion in ion-exchanged water and filtration until the electrical conductivity of the filtrate reaches or falls below 20 μS/cm. The resultant is then dried under vacuum in an oven at 40° C. for 5 hours to obtain toner particles.

The toner particles obtained (100 parts) are mixed with 1.5 parts of hydrophobic silica (RY50 manufactured by Nippon Aerosil Co., Ltd.) and 1.0 part of hydrophobic titanium oxide (T805 manufactured by Nippon Aerosil Co., Ltd.) by using a sample mill at 10,000 rpm for 30 seconds. The mixture is then sifted through a vibrating sieve with 45-μm openings to prepare a toner A1 (electrostatic image developing toner A1). The toner A1 has a volume average particle size of 5.7 μm.

### Preparation of Developer A1

The toner A1 (8 parts) is blended with a carrier (92 parts) by using a V-blender to prepare a developer A1 (electrostatic image developer A1).

The carrier used is prepared by mixing 100 parts of Mn—Sr core particles having an average particle size of 35 μm, 7.5 parts of a silicone resin (SR2411 manufactured by Dow Corning Toray Co., Ltd.), and 100 parts of toluene, then distilling off the solvent, and stirring the resultant at 150° C. for 1 hour to cure the resin.

The average particle size of the carrier is a volume-average particle size. The volume average particle size is measured as described below.

The particle size distribution of the carrier is measured using a laser diffraction/scattering particle size distribution analyzer (LS Particle Size Analyzer manufactured by Beckman Coulter, Inc.) and ISOTON-II electrolyte solution (manufactured by Beckman Coulter, Inc.). The number of measured particles is 50,000.

The particle size distribution obtained is divided into particle size classes (channels). A cumulative volume distribution is drawn from smaller particle sizes. “Volume average particle size” is defined as the particle size at which the cumulative volume is 50% (also referred to as “D50v”).

### Preparation of Developers A2 to A13 and B1 and B2

Toners A2 to A13 and toners B1 and B2, which are magenta toners, are obtained in the same manner as the toner A1 except that the resin particle dispersion, the release agent particle dispersion, the amount of aggregating agent, the coalescence temperature, the retention temperature, and the retention time are changed as shown in Table 1.

Developers A2 to A13 and developers B1 and B2, which are electrostatic image developers, are prepared in the same manner as the developer A1 except that the toners A2 to A13 and the toners B1 and B2 are respectively used.

Preparation of developer A14 A developer A14 is prepared in the same manner as the developer A1 except that the average particle size of the carrier used is changed to the value (30 μm) shown in Table 2.

### Preparation of Developer B3

A toner B3, which is a magenta toner, is obtained in the same manner as the toner A1 except that the resin particle dispersion, the release agent particle dispersion, the amount of aggregating agent, the coalescence temperature, the retention temperature, and the retention time are changed as shown in Table 1.

A developer B3, which is an electrostatic image developer, is prepared in the same manner as the developer A1 except that the toner B3 is used.

TABLE 1

| | | | | (In η(T2) − | (In η(T0) − | Maximum | | | |
|---|---|---|---|---|---|---|---|---|---|
| | | | | In η(T3))/ | In η(T1))/ | endothermic | | | |
| | | | | (T2 − T3) − | (T0 − T1) − | peak | | | |
| | (In η(T1) − | (In η(T2) − | (In η(T0) − | (In η(T1) − | (In η(T1) − | temperature | | | Resin |
| | In η(T2))/ | In η(T3))/ | In η(T1))/ | In η(T2))/ | In η(T2))/ | of toner | | | particle |
| Toner | (T1 − T2) | (T2 − T3) | (T0 − T1) | (T1 − T2) | (T1 − T2) | (° C.) | a/b | c/d | dispersion |
| A1 | −0.215 | −0.090 | −0.110 | 0.125 | 0.105 | 85 | 5.0 | 2.9 | (3) |
| A2 | −0.168 | −0.080 | −0.085 | 0.088 | 0.083 | 85 | 5.1 | 2.5 | (2) |
| A3 | −0.143 | −0.100 | −0.078 | 0.043 | 0.065 | 85 | 4.9 | 2.6 | (1) |
| A4 | −0.213 | −0.090 | −0.106 | 0.123 | 0.107 | 85 | 5.0 | 2.8 | (3) |
| A5 | −0.214 | −0.100 | −0.110 | 0.114 | 0.104 | 85 | 5.1 | 2.4 | (3) |
| A6 | −0.154 | −0.135 | −0.077 | 0.019 | 0.077 | 70 | 5.1 | 2.6 | (1) |
| A7 | −0.153 | −0.133 | −0.080 | 0.020 | 0.073 | 100 | 4.9 | 2.8 | (1) |
| A8 | −0.155 | −0.141 | −0.083 | 0.014 | 0.072 | 63 | 5.0 | 2.5 | (1) |
| A9 | −0.156 | −0.136 | −0.079 | 0.020 | 0.077 | 102 | 5.1 | 2.9 | (1) |
| A10 | −0.152 | −0.141 | −0.073 | 0.011 | 0.079 | 85 | 1.5 | 1.3 | (1) |
| A11 | −0.153 | −0.142 | −0.071 | 0.011 | 0.082 | 85 | 7.2 | 3.5 | (1) |
| A12 | −0.155 | −0.135 | −0.075 | 0.020 | 0.080 | 85 | 8.5 | 4.5 | (1) |
| A13 | −0.154 | −0.134 | −0.078 | 0.020 | 0.076 | 85 | 0.7 | 0.6 | (1) |
| B1 | −0.129 | −0.090 | −0.068 | 0.039 | 0.061 | 85 | 5.3 | 2.9 | (5) |
| B2 | −0.215 | −0.155 | −0.113 | 0.060 | 0.102 | 85 | 5.3 | 2.9 | (3) |
| B3 | −0.180 | −0.186 | −0.109 | −0.006 | 0.071 | 85 | 5.3 | 2.9 | (4) |

| | | | | | Conditions for producing toner | | | |
|---|---|---|---|---|---|---|---|---|
| | First release | | Second release | | Amount of | | | |
| | agent particle | | agent particle | | aggregating | Coalescence | Retention | |
| | dispersion | | dispersion | | agent | temperature | temperature | Retention |
| Toner | Type | Parts | Type | Parts | (parts) | (° C.) | (° C.) | time (hr) |
| A1 | (2) | 12 | (3) | 24 | 2.1 | 91 | 85 | 1 |
| A2 | (2) | 12 | (3) | 24 | 2.1 | 92 | 85 | 1 |
| A3 | (2) | 12 | (3) | 24 | 2.1 | 93 | 85 | 1 |
| A4 | (2) | 12 | (3) | 24 | 1.9 | 92 | 85 | 1 |
| A5 | (2) | 12 | (3) | 24 | 1.7 | 91 | 85 | 1 |
| A6 | (1) | 12 | (2) | 24 | 1.7 | 77 | 70 | 1 |
| A7 | (3) | 12 | (4) | 24 | 1.7 | 108 | 95 | 1 |
| A8 | (1) | 28.8 | (2) | 7.2 | 1.7 | 70 | 65 | 1 |
| A9 | (3) | 7.2 | (4) | 28.8 | 1.7 | 108 | 95 | 1 |
| A10 | (2) | 12 | (3) | 24 | 1.7 | 91 | 85 | 0.5 |
| A11 | (2) | 12 | (3) | 24 | 1.7 | 92 | 85 | 2 |
| A12 | (2) | 12 | (3) | 24 | 1.7 | 93 | 85 | 3 |
| A13 | (2) | 12 | (3) | 24 | 1.7 | 92 | 85 | 0.25 |
| B1 | (2) | 12 | (3) | 24 | 2.1 | 91 | 85 | 1 |
| B2 | (2) | 12 | (3) | 24 | 1.5 | 93 | 85 | 1 |
| B3 | (2) | 12 | (3) | 24 | 2.1 | 93 | 85 | 1 |

### Developing Rollers S1, S2, and S0

### Provision of Developing Roller S1

A developing roller S1 which has 200 grooves having a V-shaped section is provided. The width of the grooves is 175 μm, the depth of the grooves is 40 μm, the width of non-groove portions is 139 μm, and the groove pitch is 0.314 mm.

The developing roller S1 has the configuration of the developing roller 106 illustrated in FIG. 3. That is, the developing roller S1 includes the magnetic roller 106A serving as a magnetic source and the developing sleeve 106B rotatably supported outside the magnetic roller 106A. The developing sleeve 106B is a tubular aluminum member.

### Provision of Developing Roller S2

A developing roller S2 is provided. The configuration of the developing roller S2 is the same as that of the developing roller S1 except that the grooves have a U-shaped section.

### Provision of Developing Roller S0

A developing roller S0 which has no grooves is provided. Examples 101 to 114, Examples 201 to 214, Comparative Examples 101 to 103, and Reference Example 1

A commercially available electrophotographic copier (DOCU CENTRE COLOR450, manufactured by Fuji Xerox Co., Ltd.) is used as an evaluation machine. Developers shown in Table 2 are loaded into a developing device of the electrophotographic copier, and developing rollers shown in Table 2 are mounted to the developing device.

### Evaluation

### Ability to Hold Toner

The ability to hold toner is evaluated in the following manner. In a high-temperature and high-humidity environment (30° C. and 90% RH), an image with an area coverage of 5% is output on 100,000 sheets. The weight of each developer per unit area held on each developing roller is measured before and after the output. The developer weight after the output is compared with the developer weight before the output, and the percentage of decrease in developer weight is evaluated according to the following evaluation criteria. The results are shown in Table 2.

A: 15% or less

B: More than 15% and less than 30%

C: 30% or more Stability of amount of transported toner

In a high-temperature and high-humidity environment (30° C. and 90% RH), an image with an area coverage of 5% is output on 100,000 sheets, and the developer on the surface of the developing roller is then removed. The developing roller is visually observed and evaluated according to the following evaluation criteria.

A: No toner adhesion is observed.

B: Slight adhesion is observed.

C: Adhesion is observed.

### Stability of Image Quality

Using the evaluation machine, a halftone image having an image density of 30% is output on ten A4 sheets in a low-temperature and low-humidity environment (10° C. and 15% RH). For the first to tenth images, the presence of color spots due to cracking and chipping of toner is visually observed and evaluated according to the following criteria. The results are shown in Table 2.

A: No color spots are observed.

B: Slight color spots are visually observed.

C: Unacceptable color spots are observed.

TABLE 2

| | | | | | | | Relationship between | | | | |
|---|---|---|---|---|---|---|---|---|---|---|---|
| | | | | | | | grooves of supply member | | | | |
| | | | | | | | and carrier in developer | | Ratio | | |
| | | | | | Developer | | | Ratio | (shortest distance | Evaluation | |
| | Supply member | | | | | Carrier | Ratio | (average | between supply | Stability | |
| | | | Groove | Evaluation | | particle | (groove pitch/ | groove width/ | member and surface | of amount of | Stability |
| | | Groove | pitch | Ability to | | size | carrier | carrier | of regulating mem- | transported | of image |
| | Type | shape | (mm) | hold toner | Type | (μm) | particle size) | particle size) | ber/groove depth) | toner | quality |
| Example 101 | S1 | V- | 0.3 | A | A1 | 35 | 8.6 | 4.3 | 1.4 | A | A |
| Example 102 | | shaped | | | A2 | 35 | 8.6 | 4.3 | 1.4 | A | A |
| Example 103 | | | | | A3 | 35 | 8.6 | 4.3 | 1.4 | A | A |
| Example 104 | | | | | A4 | 35 | 8.6 | 4.3 | 1.4 | A | A |
| Example 105 | | | | | A5 | 35 | 8.6 | 4.3 | 1.4 | A | A |
| Example 106 | | | | | A6 | 35 | 8.6 | 4.3 | 1.4 | A | A |
| Example 107 | | | | | A7 | 35 | 8.6 | 4.3 | 1.4 | A | A |
| Example 108 | | | | | A8 | 35 | 8.6 | 4.3 | 1.4 | A | A |
| Example 109 | | | | | A9 | 35 | 8.6 | 4.3 | 1.4 | A | A |
| Example 110 | | | | | A10 | 35 | 8.6 | 4.3 | 1.4 | A | A |
| Example 111 | | | | | A11 | 35 | 8.6 | 4.3 | 1.4 | A | A |
| Example 112 | | | | | A12 | 35 | 8.6 | 4.3 | 1.4 | A | A |
| Example 113 | | | | | A13 | 35 | 8.6 | 4.3 | 1.4 | A | A |
| Example 114 | | | | | A14 | 30 | 10.0 | 5.0 | 1.7 | A | A |
| Example 201 | S2 | U- | 0.3 | A | A1 | 35 | 8.6 | 4.3 | 1.4 | A | A |
| Example 202 | | shaped | | | A2 | 35 | 8.6 | 4.3 | 1.4 | A | A |
| Example 203 | | | | | A3 | 35 | 8.6 | 4.3 | 1.4 | A | A |
| Example 204 | | | | | A4 | 35 | 8.6 | 4.3 | 1.4 | A | A |
| Example 205 | | | | | A5 | 35 | 8.6 | 4.3 | 1.4 | A | A |
| Example 206 | | | | | A6 | 35 | 8.6 | 4.3 | 1.4 | A | A |
| Example 207 | | | | | A7 | 35 | 8.6 | 4.3 | 1.4 | A | A |
| Example 208 | | | | | A8 | 35 | 8.6 | 4.3 | 1.4 | A | A |
| Example 209 | | | | | A9 | 35 | 8.6 | 4.3 | 1.4 | A | A |
| Example 210 | | | | | A10 | 35 | 8.6 | 4.3 | 1.4 | A | A |
| Example 211 | | | | | A11 | 35 | 8.6 | 4.3 | 1.4 | A | A |
| Example 212 | | | | | A12 | 35 | 8.6 | 4.3 | 1.4 | A | A |
| Example 213 | | | | | A13 | 35 | 8.6 | 4.3 | 1.4 | A | A |
| Example 214 | | | | | A14 | 30 | 10.0 | 5.0 | 1.7 | A | A |
| Comparative | S1 | V- | 0.3 | A | B1 | 35 | 8.6 | 4.3 | 1.4 | C | B |
| Example 101 | | shaped | | | | | | | | | |
| Comparative | | | | | B2 | 35 | 8.6 | 4.3 | 1.4 | C | B |
| Example 102 | | | | | | | | | | | |
| Comparative | | | | | B3 | 35 | 8.6 | 4.3 | 1.4 | C | B |
| Example 103 | | | | | | | | | | | |
| Reference | S0 | none | — | C | A1 | 35 | — | — | — | — | A |
| Example 1 | | | | | | | | | | | |

The above tables show that when image forming apparatuses of Examples, in each of which a toner satisfying conditions (ln η(T1)−ln η(T2))/(T1−T2)≤−0.14, (ln η(T2)−ln η(T3))/(T2−T3)≥−0.15, and (ln η(T2)−ln η(T3))/(T2−T3)>(ln η(T1)−ln η(T2))/(T1−T2) is used, are used, the amount of toner transported by the supply member is stabilized, and the occurrence of color spots in images is reduced, as compared to when image forming apparatuses of Comparative Examples, in each of which a toner not satisfying at least one of these conditions is used, are used.

In Reference Example, a supply member having no grooves is used, and the ability to hold toner is beyond the acceptable level. Thus, the stability of the amount of transported toner is not evaluated.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus comprising:
an image carrier;
a charging device that charges a surface of the image carrier;
an electrostatic image forming device that forms an electrostatic image on the charged surface of the image carrier;
a developing device that includes a container and a supply member and develops the electrostatic image formed on the surface of the image carrier to form a toner image, the container containing an electrostatic image developer that contains an electrostatic image developing toner and a carrier, the supply member having in a circumferential surface thereof a plurality of grooves extending in a direction intersecting a direction of rotation of the supply member, the electrostatic image being developed with the electrostatic image developer;
a transfer device that transfers the toner image formed on the surface of the image carrier to a recording medium; and
a fixing device that fixes the toner image transferred to the recording medium,
wherein the electrostatic image developing toner satisfies inequalities below:
(ln η(T1)−ln η(T2))/(T1−T2)≤−0.14
(ln η(T2)−ln η(T3))/(T2−T3)≥−0.15
(ln η(T1)−ln η(T2))/(T1−T2)<(ln η(T2)−ln η(T3))/(T2−T3)
wherein η(T1) represents a viscosity of the electrostatic image developing toner at 60° C., η(T2) represents a viscosity of the electrostatic image developing toner at 90° C., and η(T3) represents a viscosity of the electrostatic image developing toner at 130° C.

2. The image forming apparatus according to claim 1, wherein the electrostatic image developing toner satisfies (ln η(T0)−ln η(T1))/(T0−T1)≥−0.12 and (ln η(T0)−ln η(T1))/(T0−T1)>(ln η(T1)−ln η(T2))/(T1−T2), wherein η(T0) is a viscosity η of the electrostatic image developing toner at temperature T0=40° C.

3. The image forming apparatus according to claim 1, wherein the electrostatic image developing toner satisfies the following inequality:
(ln η(T1)−ln η(T2))/(T1−T2)≤−0.16.

4. The image forming apparatus according to claim 1, wherein the electrostatic image developing toner satisfies the following inequality:
(ln η(T2)−ln η(T3))/(T2−T3)≥−0.13.

5. The image forming apparatus according to claim 1, wherein the electrostatic image developing toner contains a release agent, and
the electrostatic image developing toner satisfies the following inequality:
1.0<a/b<8.0
wherein a is a number of domains formed of the release agent and having an aspect ratio of 5 or more in the electrostatic image developing toner, and b is a number of domains formed of the release agent and having an aspect ratio of less than 5 in the electrostatic image developing toner.

6. The image forming apparatus according to claim 1, wherein the electrostatic image developing toner contains a release agent, and
the electrostatic image developing toner satisfies the following inequality:
1.0<c/d<4.0
wherein c is an area of domains formed of the release agent and having an aspect ratio of 5 or more in the electrostatic image developing toner, and d is an area of domains formed of the release agent and having an aspect ratio of less than 5 in the electrostatic image developing toner.

7. The image forming apparatus according to claim 1, wherein the electrostatic image developing toner has a maximum endothermic peak temperature in a range of 70° C. to 100° C.

8. The image forming apparatus according to claim 1, wherein the electrostatic image developing toner has a maximum endothermic peak temperature in a range of 75° C. to 95° C.

9. The image forming apparatus according to claim 1, wherein the electrostatic image developing toner contains a styrene-acrylic resin serving as a binder resin.

10. The image forming apparatus according to claim 1, wherein the plurality of grooves each have a V-shaped section as viewed in an axial direction of the supply member.

11. The image forming apparatus according to claim 1, wherein the developing unit includes a regulating device that regulates the amount of developer on the supply member.

12. The image forming apparatus according to claim 1, wherein a ratio (L2/L1) of an average pitch (L2) of the grooves to an average particle size (L1) of the carrier is in a range of 5.7 to 17.1.

13. The image forming apparatus according to claim 1, wherein a ratio (L3/L1) of an average width (L3) of the grooves to an average particle size (L1) of the carrier is in a range of 2.8 to 8.6.

14. The image forming apparatus according to claim 11, wherein a ratio (L5/L4) of a shortest distance (L5) between the regulating member and a surface of the supply member to a depth (L4) of the grooves is 1.4 or more.

15. A process cartridge attachable to and detachable from an image forming apparatus, the process cartridge comprising:
a developing device that includes a container and a supply device and develops an electrostatic image formed on a surface of an image carrier, the container containing an electrostatic image developer that contains an electrostatic image developing toner and a carrier, the supply device having in a circumferential surface thereof a plurality of grooves extending in a direction intersecting a direction of rotation of the supply member, the electrostatic image being developed with the electrostatic image developer,
wherein the electrostatic image developing toner satisfies inequalities below:
(ln η(T1)−ln η(T2))/(T1−T2)≤−0.14
(ln η(T2)−ln η(T3))/(T2−T3)≥−0.15
(ln η(T1)−ln η(T2))/(T1−T2)<(ln η(T2)−ln η(T3))/(T2−T3)
wherein η(T1) represents a viscosity of the electrostatic image developing toner at 60° C., η(T2) represents a viscosity of the electrostatic image developing toner at 90° C., and η(T3) represents a viscosity of the electrostatic image developing toner at 130° C.
